(19) United States
(12) Patent Application Publication
(10) Pub. No.: US 2004/0041822 A1
(43) Pub. Date: Mar. 4, 2004

(54) Image processing apparatus, image processing method, studio apparatus, storage medium, and program

(75) Inventors: Yoshio Iizuka, Kanagawa (JP); Hiroaki Sato, Tokyo (JP); Tomoaki Kawai, Kanagawa (JP); Hideo Noro, Tokyo (JP); Eita Ono, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA

(21) Appl. No.: 10/654,014

(22) Filed: Sep. 4, 2003

Related U.S. Application Data
(63) Continuation of application No. PCT/JP02/02344, filed on Mar. 13, 2002.

(30) Foreign Application Priority Data
Mar. 13, 2001 (JP) 2001-071124
Mar. 13, 2001 (JP) 2001-071112

(51) Int. Cl. G09G 5/00

(52) U.S. Cl. 345/634

(57) ABSTRACT

This invention provides an image processing method, image processing apparatus, storage medium, and program, which can remove the boundary between real and virtual worlds. To this end, an apparatus has a image input device (101), the image input parameters of which are controllable, a position/posture sensor (102) for acquiring the image input parameters, a CG data management unit (108) for managing CG (computer graphics) data, a CG geometric information calculation unit (110) for calculating CG geometric information upon virtually laying out the CG data in the real world, a CG image generator (109) for generating a CG image from the viewpoint of the image input device (101), a image composition device (113) for compositing a real image and CG image, and a data processing device (107) for changing the image input parameters using the image input parameters and the CG geometric information.

### TECHNICAL FIELD

The present invention relates to an image processing apparatus, image processing method, studio apparatus, storage medium, and program for processing a real image and CG (computer graphics) image.

### BACKGROUND ART

A method of extracting a portion of a real image, and superimposing it on a CG image (or superimposing a CG image on a portion where a real image is cut) is available, and is roughly classified into a chromakey method, rotoscoping method, difference matching method, and the like depending on the way a real image is extracted.

In the chromakey method, image input is made using a blueback (an object is image inputted in front of a uniform blue or green wall as a background), and a region other than the background color is automatically extracted. FIG. 19 shows this method.

Referring to FIG. 19, reference numeral 1901 denotes a studio; 1902, an object; 1903, a camera; 1904, a image inputted by the camera 1903; 1905, a CG image created separately; 1906, a image inputted at another location; 1907, chromakey as an image composition means; and 1908, a composite image obtained by the chromakey 1907.

In the studio 1901, the object 1902 is image inputted by the camera 1903 using a blue or green wall called a blueback 1909, another image 1905 or 1906 is composited on the portion of the blueback 1909 by the chromakey 1907, and the obtained composite image 1908 is recorded or broadcasted as a video.

In the rotoscoping method, a image region including an object image is extracted manually.

In the difference matching method, a image including an object image is taken first while recording a image input condition, a image which does not include any object image is then taken while reproducing the recorded image input condition (i.e., under the same image input condition as that for the first image), and a difference region between the two images is automatically extracted.

As a technique for solving problems of these prior arts, Japanese Patent Laid-Open No. 2000-23037 has been proposed. In Japanese Patent Laid-Open No. 2000-23037, three-dimensional (3D) information of an object during image inputting is measured, a CG image is composited based on the measured 3D information, and a composite image is displayed, so that a performer can act in a image input site or a CG character can be animated while observing the composite image.

As another technique for solving problems of these prior arts, a method using a motion-controlled camera has been proposed. In this method, image input parameters (the position, direction, zoom ratio, focus value, and the like of a camera as image input means) for respective image input times are determined in accordance with a scenario created in advance, and image input is made while moving the camera according to the image input parameters for respective times. On the other hand, since a CG image is created according to the scenario, actions of a real image can accurately match those of the CG image.

As a technique for solving problems of some prior art including the method using the motion-controlled camera in terms of creation of virtual reality, Japanese Patent Laid-Open No. 10-208073 has been proposed. In Japanese Patent Laid-Open No. 10-208073, a camera is attached to a moving robot, and a CG image is superimposed on a real image in correspondence with the movement of the moving robot, so that the actions of the real image can be easily synchronized with those of the CG image. For example, when a CG character is rendered to occlude the real image of another moving robot, if a performer and moving robot act interactively, they appear to act interactively in a composite image.

As an applied system that composites a real image and CG image, for example, Japanese Patent Laid-Open Nos. 11-309269 and 11-88913 have been proposed. In these references, a real image is used as a background, and a CG image or the like is superimposed on that background, thus compositing the real image and CG image.

Furthermore, as the use pattern of images taken in this way, experiments of interactive television systems using the Internet have been extensively made.

However, Japanese Patent Laid-Open No. 2000-23037 mentioned above suffers the following problems. •Since no moving means of the image input means (camera) is provided, free camerawork cannot be made. •Since a composite image is generated at the viewpoint of a performer, the performer can hardly recognize the distance between himself or herself and a CG character. Therefore, it is difficult to synchronize the actions of the performer and CG character. •Since a composite image is not displayed in front of the eyes of the performer, it is difficult for the performer to act while observing the composite image. Therefore, it is difficult to synchronize the actions of the performer and CG character.

Also, Japanese Patent Laid-Open No. 10-208073 suffers the following problems. •Since the performer indirectly recognizes the presence of a CG character via a mark such as a moving robot or the like, even when the CG character is laid out at a position where no mark is present, the performer cannot notice the CG character. Also, even when the CG character expresses actions that the mark cannot express, the performer cannot notice such actions. •Since no 3D information of an object during image inputting is measured, and since the position, size, and shape of a CG character which is to be virtually laid out in a real world are not calculated, even when portions of the object and CG character collide each other in a composite image, such collision cannot be detected (although collision between an object and moving robot can be detected, the sizes and shapes of the moving robot and CG character do not always match). Therefore, even when the object must be displayed in front of the CG character in the composite image, the CG character may be rendered in front of the object.

In the method using the blueback 1909 shown in FIG. 19, since the performer cannot see a image to be composited, his or her action may become unnatural or the degree of freedom in action may be reduced.

In Japanese Patent Laid-Open Nos. 11-309269 and 11-88913 mentioned above, when the relationship between a real image and image to be composited is fixed, positional deviations between the images are negligible. However, when a performer, camera, virtual object, and the like move largely and intricately, it is difficult to obtain an accurate composite image.

On the other hand, in recent years, upon development of head-mounted displays, wearable computers, and the like, a performer can act while observing a composite image in real time. However, practical user services using such devices have not been proposed yet.

In interactive television experiments conducted so far, viewer participation in terms of camerawork and scenario development have been examined. However, in such experiments, performers cannot directly see virtual characters that serve as viewers. For this reason, interactions between the viewers and performers are limited considerably.

The present invention has been made in consideration of the above problems, and has as its first object to provide an image processing method, image processing apparatus, storage medium, and program, which can remove the boundary between a real world and virtual world.

It is the second object of the present invention to provide an image processing method, image processing apparatus, and studio apparatus, which can remove unnatural actions and can increase the degree of freedom in action, and allow a performer to simultaneously experience a situation in which a viewer in home participates via the Internet so as to allow cooperation and interaction between the viewer's home and studio.

Conventionally, upon shooting a movie or television program, a performer may often wear costumes that cover his or her whole body so as to act as various characters in accordance with a scenario.

In this case, the size of such costume strongly depends on that of the performer, and it is impossible for the performer to act as an extremely large character or a character whose size, material, shape, and the like change according to the progress of a scenario.

Even when only the performer is image inputted in another studio using an MR technique, since the performer does not exist at a given site or there are no obstacles of a real studio setting, a sense of reality impairs for the performer who wears a costume and a co-performer.

When the performers and characters that those performers act have nearly a constant size ratio, they can act together. However, if image input is made in another studio, actions themselves become very difficult.

This is also apparent from the fact that swords do not collide against each other in a real space upon flight with a character in costume.

Furthermore, when a performer wears an actual costume, the physical characteristics of the costume are largely influenced by its material.

In addition, since an actual costume is heavy, quick actions of a character are limited.

A performer who wears a costume normally feels muggy. Such feeling imposes a heavy load on the performer, and it is difficult to continue image input for a long period of time.

The present invention has been made in consideration of the above problems, and has as its third object to provide an image processing method, image processing apparatus, storage medium, and program, which allow a performer to act as a character which is extremely larger than the performer or a character whose size, color, and shape change in accordance with progress of a scenario, can provide a sense of reality to a performer who wears a costume, and another performer who acts together with that performer, can freely set the physical characteristics of a character in costume, can relax limitations on quick actions of a character in a real costume, can reduce the load on the performer due to an actual muggy costume, and can relax difficulty in image input for a long period of time.

### DISCLOSURE OF INVENTION

In order to achieve the first object, an image processing method cited in claim 1 of the present invention comprises a image input step of taking an image using image input means, a image input parameter of which is controllable, a image input parameter acquisition step of acquiring the image input parameter, a CG data management step of managing CG (computer graphics) data, a CG geometric information calculation step of calculating CG geometric information upon virtually laying out the CG data in a real world, a CG image generation step of generating a CG image from a viewpoint of the image input means, a image composition step of compositing a real image and the CG image, and a image input parameter control step of changing the image input parameter using the image input parameter and the CG geometric information.

In order to achieve the first object, an image processing apparatus cited in claim 12 of the present invention comprises a image input means, a image input parameter of which is controllable, a image input parameter acquisition means that acquires the image input parameter, a CG data management means that manages CG (computer graphics) data, a CG geometric information calculation means that calculates CG geometric information upon virtually laying out the CG data in a real world, a CG image generation means that generates a CG image from a viewpoint of the image input means, a image composition means that composites a real image and the CG image, and a image input parameter control means that changes the image input parameter using the image input parameter and the CG geometric information.

In order to achieve the second object, an image processing method cited in claim 13 of the present invention comprises a image input step of image inputting an image using image input means, a studio set step of forming a background, a display step of displaying an image using display means that a staff member associated with an image process wears, a first measurement step of measuring a image input parameter of the image input means, a second measurement step of measuring a display parameter of the display means, a CG data management step of managing CG (computer graphics) data, a first CG image generation step of generating a CG image from a viewpoint of the image input means, a image composition step of compositing an image taken by the image input means, and the CG image generated in the first CG image generation step, a second CG image generation step of generating a CG image from a viewpoint of the display means, a image superimpose step of superimposing the CG image on a real space that can be seen from the display means, a image broadcast step of broadcasting an image composited in the image composition step, a viewer information management step of managing viewer information, a scenario management step of setting the viewer information in a portion of a scene, and a prohibited region processing step of controlling a range in which a CG object is present.

In order to achieve the second object, an image processing apparatus cited in claim 25 of the present invention comprises a image input means that image input an image, a studio set means that forms a background, a display means, worn by a staff member associated with an image process, for displaying an image, a first measurement means that measures a image input parameter of the image input means, a second measurement means that measures a display parameter of the display means, a CG data management means that manages CG (computer graphics) data, a first CG image generation means that generates a CG image from a viewpoint of the image input means, a image composition means that composites an image taken by the image input means, and the CG image generated by the first CG image generation means, a second CG image generation means that generates a CG image from a viewpoint of the display means, a image superimpose means that superimposes the CG image on a real space that can be seen from the display means, a image broadcast means that broadcastes an image composited by the image composition means, a viewer information management means that manages viewer information, a scenario management means that sets the viewer information in a portion of a scene, and a prohibited region processing means that controls a range in which a CG object is present.

In order to achieve the second object, a studio apparatus cited in claim 26 of the present invention equips an image processing apparatus cited in claim 25.

In order to achieve the first object, a storage medium cited in claim 27 of the present invention is a storage medium that stores a computer-readable control program for controlling an image processing apparatus for processing a real image and a CG (computer graphics) image, comprising a program code for making a computer execute, a image input step of taking an image using image input means, a image input parameter of which is controllable, a image input parameter acquisition step of acquiring the image input parameter, a CG data management step of managing CG (computer graphics) data, a CG geometric information calculation step of calculating CG geometric information upon virtually laying out the CG data in a real world, a CG image generation step of generating a CG image from a viewpoint of the image input means, a image composition step of compositing a real image and the CG image, and, a image input parameter control step of changing the image input parameter using the image input parameter and the CG geometric information.

In order to achieve the second object, a storage medium cited in claim 28 of the present invention is a storage medium that stores a computer-readable control program for controlling an image processing apparatus for processing a real image and a CG (computer graphics) image, comprising a program code for making a computer execute, a image input step of image inputting an image using image input means, a studio set step of forming a background, a display step of displaying an image using display means that a staff member associated with an image process wears, a first measurement step of measuring a image input parameter of the image input means, a second measurement step of measuring a display parameter of the display means, a CG data management step of managing CG (computer graphics) data, a first CG image generation step of generating a CG image from a viewpoint of the image input means, a image composition step of compositing an image taken by the image input means, and the CG image generated in the first CG image generation step, a second CG image generation step of generating a CG image from a viewpoint of the display means, a image superimpose step of superimposing the CG image on a real space that can be seen from the display means, a image broadcast step of broadcasting an image composited in the image composition step, a viewer information management step of managing viewer information, a scenario management step of setting the viewer information in a portion of a scene, and, a prohibited region processing step of controlling a range in which a CG object is present.

In order to achieve the first object, a program cited in claim 29 of the present invention is a computer-readable control program for controlling an image processing apparatus for processing a real image and a CG (computer graphics) image, comprising a program code for making a computer execute, a image input step of taking an image using image input means, a image input parameter of which is controllable, a image input parameter acquisition step of acquiring the image input parameter, a CG data management step of managing CG (computer graphics) data, a CG geometric information calculation step of calculating CG geometric information upon virtually laying out the CG data in a real world, a CG image generation step of generating a CG image from a viewpoint of the image input means, a image composition step of compositing a real image and the CG image, and, a image input parameter control step of changing the image input parameter using the image input parameter and the CG geometric information.

In order to achieve the second object, a program cited in claim 30 of the present invention is a computer-readable control program for controlling an image processing apparatus for processing a real image and a CG (computer graphics) image, comprising a program code for making a computer execute, a image input step of image inputting an image using image input means, a studio set step of forming a background, a display step of displaying an image using display means that a staff member associated with an image process wears, a first measurement step of measuring a image input parameter of the image input means, a second measurement step of measuring a display parameter of the display means, a CG data management step of managing CG (computer graphics) data, a first CG image generation step of generating a CG image from a viewpoint of the image input means, a image composition step of compositing an image taken by the image input means, and the CG image generated in the first CG image generation step, a second CG image generation step of generating a CG image from a viewpoint of the display means, a image superimpose step of superimposing the CG image on a real space that can be seen from the display means, a image broadcast step of broadcasting an image composited in the image composition step, a viewer information management step of managing viewer information, a scenario management step of setting the viewer information in a portion of a scene, and, a prohibited region processing step of controlling a range in which a CG object is present.

In order to achieve the third object, an image processing method cited in claim 31 of the present invention comprises a tracking step of measuring a position/posture of an object such as a performer or the like, and, an affecting CG data step of reflecting the position/posture obtained in the tracking step in CG (computer graphics) data to be superimposed on an image of the object.

In order to achieve the third object, an image processing apparatus cited in claim 32 of the present invention comprises a tracking means that measures a position/posture of an object such as a performer or the like, and, an affecting CG data means that reflects the position/posture obtained by the tracking means in CG (computer graphics) data to be superimposed on an image of the object.

In order to achieve the third object, an image processing method cited in claim 33 of the present invention is an image processing method for measuring a position/posture of an object such as a performer or the like, and reflecting the measured position/posture in CG (computer graphics) data to be superimposed on an image of the object to display the CG data on display means, comprising, a image input step of image inputting the object using image input means, a CG image generation step of generating a CG image from a viewpoint of the image input means on the basis of a image input parameter of the image input means and a display parameter of the display means, a image composition step of compositing a real image of the object taken by the image input means with the CG image generated in the CG image generation step, and displaying a composite image on the display means, and, a prohibited region processing step of limiting in the image composition step a range in which the CG image is present.

In order to achieve the third object, an image processing apparatus cited in claim 40 of the present invention is an image processing apparatus for measuring a position/posture of an object such as a performer or the like, and reflecting the measured position/posture in CG (computer graphics) data to be superimposed on an image of the object to display the CG data on display means, comprising, image input means that image input the object, CG image generation means that generates a CG image from a viewpoint of the image input means on the basis of a image input parameter of the image input means and a display parameter of the display means, image composition means that composites a real image of the object taken by the image input means with the CG image generated by the CG image generation means, and displaying a composite image on the display means, and, prohibited region processing means that limits in an image composition process of the image composition means a range in which the CG image is present.

In order to achieve the third object, a storage medium cited in claim 41 of the present invention is a storage medium that stores a computer-readable control program for controlling an image processing apparatus for processing a real image and a CG (computer graphics) image, comprising a program code for making a computer execute a tracking step of measuring a position/posture of an object such as a performer or the like, and, an affecting CG data step of reflecting the position/posture obtained in the tracking step in CG (computer graphics) data to be superimposed on an image of the object.

In order to achieve the third object, a storage medium cited in claim 42 of the present invention is a storage medium that stores a computer-readable control program for controlling an image process for measuring a position/posture of an object such as a performer or the like, and reflecting the measured position/posture in CG (computer graphics) data to be superimposed on an image of the object to display the CG data on display means in an image processing apparatus for processing a real image and a CG (computer graphics) image, comprising a program code for making a computer execute a image input step of image inputting the object using image input means, a image generation step of generating a CG image from a viewpoint of the image input means on the basis of a image input parameter of the image input means and a display parameter of the display means, a image composition step of compositing a real image of the object taken by the image input means with the CG image generated in the CG image generation step, and displaying a composite image on the display means, and, a prohibited region processing step of limiting in the image composition step a range in which the CG image is present.

In order to achieve the third object, a program cited in claim 44 of the present invention is a computer-readable control program for controlling an image processing apparatus for processing a real image and a CG (computer graphics) image, comprising a program code for making a computer execute a tracking step of measuring a position/posture of an object such as a performer or the like, and, an affecting CG data step of reflecting the position/posture obtained in the tracking step in CG (computer graphics) data to be superimposed on an image of the object.

In order to achieve the third object, a program cited in claim 45 of the present invention is a computer-readable control program for controlling an image process for measuring a position/posture of an object such as a performer or the like, and reflecting the measured position/posture in CG (computer graphics) data to be superimposed on an image of the object to display the CG data on display means in an image processing apparatus for processing a real image and a CG (computer graphics) image, comprising a program code for making a computer execute a image input step of image inputting the object using image input means, a CG image generation step of generating a CG image from a viewpoint of the image input means on the basis of a image input parameter of the image input means and a display parameter of the display means, a image composition step of compositing a real image of the object taken by the image input means with the CG image generated in the CG image generation step, and displaying a composite image on the display means, and, a prohibited region processing step of limiting in the image composition step a range in which the CG image is present.

Other features and advantages of the present invention will be apparent from the following description taken in conjunction with the accompanying drawings, in which like reference characters designate the same or similar parts throughout the figures thereof.

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 is a block diagram showing the system arrangement of an image processing apparatus according to the first embodiment of the present invention;

FIG. 2 is a schematic view showing a image input scene upon generating a composite image using the image processing apparatus according to the first embodiment of the present invention;

FIG. 3 is a block diagram showing the system arrangement of an image processing apparatus according to the second embodiment of the present invention;

FIG. 4 is a view showing the internal structure of an HMD;

FIG. 5 is a block diagram showing details of the operation of the image processing apparatus according to the second embodiment of the present invention;

FIG. 6 is a perspective view showing the structure of a camera device in the image processing apparatus according to the second embodiment of the present invention;

FIG. 7 is a perspective view showing the structure of a hand-held camera device using a magnetic position/direction sensor in the image processing apparatus according to the second embodiment of the present invention;

FIG. 8 is a flow chart showing the flow of the processing operation for generating a image to be displayed on the HMD in the image processing apparatus according to the second embodiment of the present invention;

FIG. 9 is a flow chart showing the flow of the processing operation for determining a head position in the image processing apparatus according to the second embodiment of the present invention;

FIG. 10 shows an example of a marker in the image processing apparatus according to the second embodiment of the present invention;

FIG. 11 is a flow chart showing the flow of the processing operation for determining a marker position in the image processing apparatus according to the second embodiment of the present invention;

FIG. 12 is a flow chart showing the flow of the processing operation of a image superimpose device in the image processing apparatus according to the second embodiment of the present invention;

FIG. 13 is a block diagram showing the arrangement of a image generation device in the image processing apparatus according to the second embodiment of the present invention;

FIG. 14 is a flow chart showing the flow of the processing operation of viewer information management means in the image processing apparatus according to the second embodiment of the present invention;

FIG. 15 is a flow chart showing the flow of the processing operation of an operating device in the image processing apparatus according to the second embodiment of the present invention;

FIG. 16 is a flow chart showing the flow of the processing operation of viewer information management means in an image processing apparatus according to the third embodiment of the present invention;

FIG. 17 is a flow chart showing the flow of the processing operation of scenario management means in the image processing apparatus according to the third embodiment of the present invention;

FIG. 18 is a block diagram showing details of the operation in an image processing apparatus according to the fourth embodiment of the present invention;

FIG. 19 is a view for explaining prior art;

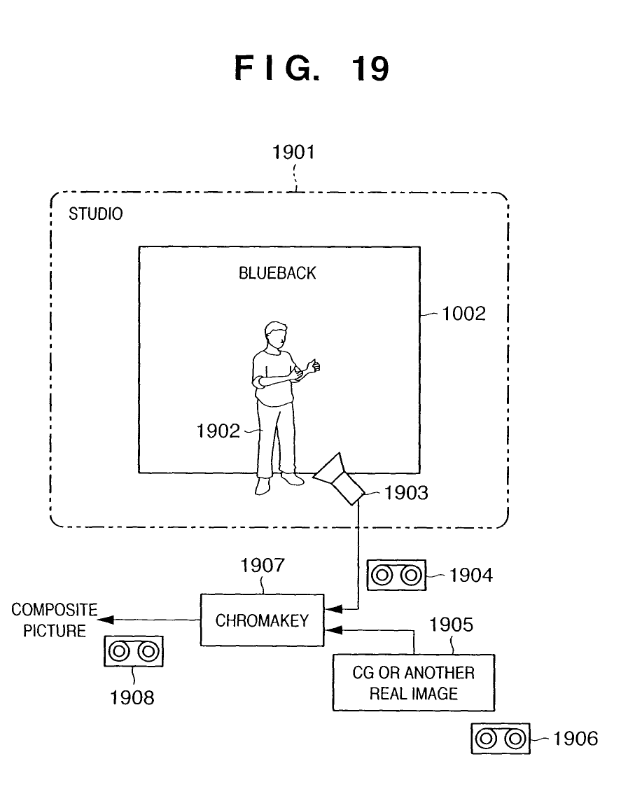

FIG. 20 is a diagram showing the system arrangement of a studio which comprises an image processing apparatus according to the sixth embodiment of the present invention;

FIG. 21 is a block diagram showing details of the operation in the image processing apparatus according to the sixth embodiment of the present invention;

FIG. 22 is a flow chart showing the flow of the processing operation of an operating device in the image processing apparatus according to the sixth embodiment of the present invention;

FIG. 23 is a bird's-eye view of the studio that comprises the image processing apparatus according to the sixth embodiment of the present invention to show the simplest prohibited region;

FIG. 24 is a flow chart showing the flow of the processing operation of prohibited region processing means in the image processing apparatus according to the sixth embodiment of the present invention;

FIG. 25 is a bird's-eye view of the studio that comprises the image processing apparatus according to the sixth embodiment of the present invention to show strictly prohibited regions;

FIG. 26 is a side view of the studio that comprises the image processing apparatus according to the sixth embodiment of the present invention to show prohibited regions;

FIG. 27 is a diagram showing the system arrangement of a studio which comprises an image processing apparatus according to the seventh embodiment of the present invention; and

FIG. 28 is a block diagram showing details of the operation of the image processing apparatus according to the seventh embodiment of the present invention.

### BEST MODE FOR CARRYING OUT THE INVENTION

Preferred embodiments of the present invention will now be described in detail in accordance with the accompanying drawings.

### First Embodiment

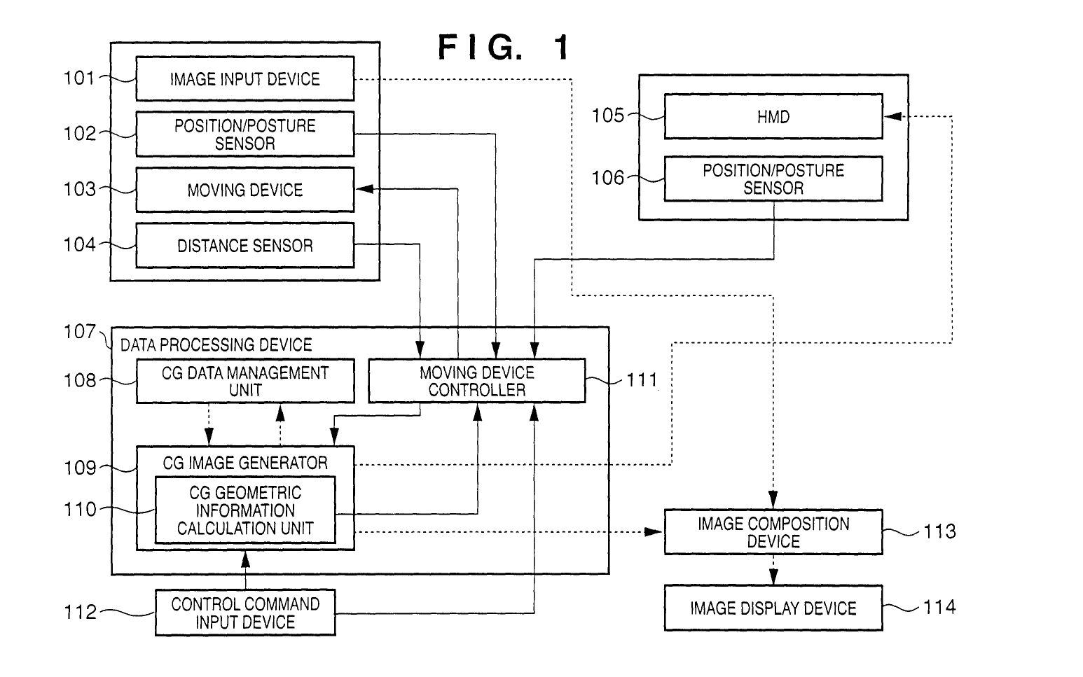

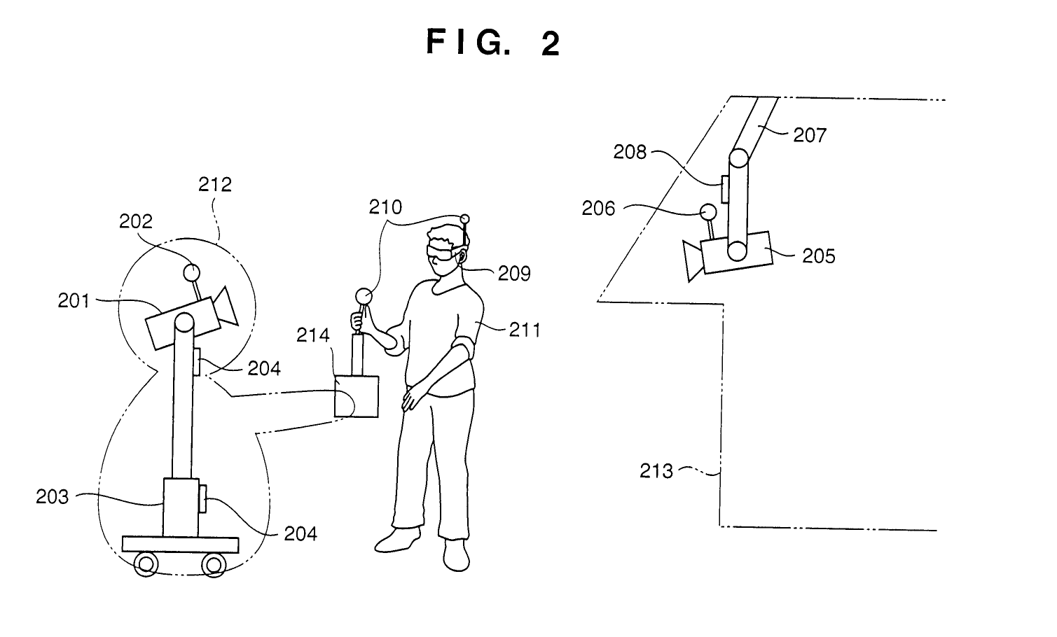

The first embodiment of the present invention will be described below with reference to FIGS. 1 and 2.

FIG. 1 is a block diagram showing the system arrangement of an image processing apparatus according to this embodiment. Although the internal arrangements of most of devices in FIG. 1 are not described, each of these devices comprises a controller and communication unit, and cooperates with other devices via communications. The communication function of the communication unit of any device can be changed by exchanging a module. Therefore, the communication units may be connected via wired or wireless connections. In FIG. 1, the solid lines with arrows indicate the flow of control data, the dotted lines with arrows indicate the flow of CG (computer graphics) data or a CG image, and the broken line with an arrow indicates the flow of a real image or composite image.

In FIG. 1, reference numeral 101 denotes a image input device (image input means); 102, a position/posture sensor (image input parameter acquisition means); 103, a moving device; 104, a distance sensor; 105, an HMD (head-mounted display) serving as display means; 106, a position/posture sensor (display parameter acquisition means); 107, a data processor; 108, a CG data management unit; 109, a CG image generator (CG image generation means); 110, a CG geometric information calculation unit (CG geometric information calculation means); 111, a moving device controller; 112, a control command input device; 113, a image composition device (image composition means); and 114, a image display device.

The image input device 101 and distance sensor 104 are attached to the moving device 103. Also, the position/posture sensor 102 is attached to the image input device 101. The relationship among these attached devices will be described later using FIG. 2.

The moving device 103 controls the movement and posture in accordance with control information received from the moving device controller 111. In this way, the image input device 101 can take images in every directions from an arbitrary position. The image input device 101 sends a real image to the image composition device 113.

The position/posture sensor 102 measures the position and posture of the image input device 101 in a predetermined coordinate system in a real world, and sends measured data (image input position/posture information) to the moving device controller 111. The image input position/posture information is also sent to the CG image generator 109 via the moving device controller 111.

The distance sensor 104 measures the distance to an object which is present in a predetermined direction and within a predetermined distance range from a predetermined position on the moving device 103, converts the measured data into distance data (obstacle information) from the viewpoint of the image input device 101, and sends the converted data to the moving device controller 111. The obstacle information is also sent to the CG image generator 109 via the moving device controller 111.

The position/posture sensor 106 is attached to the HMD 105. The position/posture sensor 106 measures the position and posture of the HMD 105 in a predetermined coordinate system in a real world, and sends measured data (image input position/posture information of the HMD 105) to the moving device controller 111. The image input position/posture information of the HMD 105 is also sent to the CG image generator 109 via the moving device controller 111. Note that the moving device controller 111 does not always require the position/posture information of the HMD 105. Hence, the position/posture information of the HMD 105 may be directly sent to the CG image generator 109 (without going through the moving device controller 111).

The control command input device 112 inputs commands (control commands) for controlling the actions of a virtual object or CG character that appears in a CG image or the position/posture of the moving device 101. As a control command input method, various methods such as key depression, mouse operation, joystick operation, touch panel depression, voice input using a speech recognition technique, gesture input using an image recognition technique, and the like, are available, and any of these methods may be used.

The data processor 107 has the CG data management unit 108, CG image generator 109, CG geometric information calculation unit 110, and moving device controller 111. FIG. 1 illustrates the data processor 107 as a single device, but the data processor 107 may comprise a group of a plurality of devices. For example, the CG data management unit 108 may be arranged in the first device, the CG image generator 109 and CG geometric information calculation unit 110 for generating CG data from the viewpoint of the image input device 101 (to be described later) may be arranged in the second device, the CG image generator 109 and CG geometric information calculation unit 110 for generating CG data from the viewpoint of the HMD 105 may be arranged in the third device, and the moving device controller 111 may be arranged in the fourth device. As the data processor 107 described in this embodiment, arbitrary data processing devices such as a personal computer, workstation, versatile computer, dedicated computer or dedicated hardware, and the like may be used.

In this embodiment, CG geometric information is calculated in the CG image generation process. Therefore, the CG geometric information calculation unit 110 is included in the CG image generator 109, but the CG geometric information calculation unit 110 need not always be included in the CG image generator 109. Hence, the CG image generator 109 and CG geometric information calculation unit 110 may be independent modules as long as they can appropriately exchange data.

The CG data management unit 108 manages storage, update, and the like of various data required to generate CG images. The CG geometric information calculation unit 110 calculates geometric information (information of position, shape, size, and the like) upon virtually laying out a virtual object or CG character expressed by CG data read out from the CG data management unit 108 via the CG image generator 109 in a predetermined coordinate system in a real world.

The CG image generator 109 reads and writes some CG data from the CG data management unit 108 as needed. The CG image generator 109 moves and modifies a virtual object or CG character in accordance with a control command. In this case, since a portion of the CG data is rewritten, the CG image generator 109 passes the rewritten CG data to the CG geometric information calculation unit 110 and controls it to calculate CG geometric information.

The CG image generator 109 calculates using the CG geometric information and obstacle information whether or not a portion of the virtual object or CG character virtually collides against an obstacle (real object). If any collision is detected, the generator 109 changes the shape, color, and the like of the virtual object or CG character in accordance with the degree of collision. In this case, since a portion of the CG data is rewritten, the CG image generator 109 passes the rewritten CG data to the CG geometric information calculation unit 110 and controls it to calculate CG geometric information. After that, the updated geometric information is sent from the CG geometric information calculation unit 110 to the moving device controller 111.

The CG image generator 109 then generates a CG image (a image of the virtual object or CG character) from the viewpoint of the image input device 101 using the updated CG data, updated CG geometric information, and image input position/posture information. Also, he CG image generator 109 generates a CG image from the viewpoint of the HMD 105 using the updated CG data, updated CG geometric information, and image input position/posture information of the HMD 105. The CG image from the viewpoint of the image input device 101 is sent to the image composition device 113, and the CG image from the viewpoint of the HMD 105 is sent to the HMD 105.

The moving device controller 111 calculates control information using the control command, obstacle information, updated CG geometric information, and image input position/posture information so as to prevent the moving device 103 from colliding against the obstacle (real object) and the virtual object or CG character, and to control to stably change the position and posture of the moving device 103, and sends the control information to the moving device 103.

The HMD 105 is a see-through type HMD (an HMD of a type that allows external light to transmit through a region where no image is displayed). The HMD 105 displays the CG image received from the CG image generator 109, but external light is transmitted through the region where no CG image is displayed. Hence, the user who wears the HMD 105 can observe a composite image of the CG image and a scene in front of him or her. Therefore, the user who wears the HMD 105 can act interactively with the CG image.

The image composition device 113 composites the real image received from the image input device 101 and the CG image received from the CG image generator 109, and sends the composite image to the image display device 114. The image display device 114 displays the composite image. As the image display device 114, arbitrary display devices such as various types of displays (CRT display, liquid crystal display, plasma display, and the like), various type of projectors (forward projection type projector, backward projection type projector, and the like), non-transmission type HMD (an HMD of a type that does not allow external light to transmit through), and the like can be used.

Normally, the image display device 114 is set near a person (operator) who inputs a control command to the control command input device 112, and the operator inputs the control command while observing the composite image. In this manner, the operator can issue a control command to interactively move the real image and CG image. That is, the CG character can freely touch or dodge the obstacle in the real image, attack or dodge the virtual object in the CG image, and dance with a performer (who wears the HMD) in the real image.

Note that the operator of the control command input device 112 may be an expert operator or an end user. Also, a plurality of operators may be present, and the operator may be present in a site different from the image input site. For example, when operators are a plurality of end users who live in distant places, the control command input device 112 and image display device 114 can be set in each user's home.

In such case, a device that combines control commands received from a plurality of control command input devices 112 into one, and a image distributor for distributing the composite image sent from the image composition device 113 to a plurality of image display devices 114 must be added.

FIG. 2 is a schematic view showing a image input scene upon generating the composite image using the image processing apparatus according to this embodiment.

Referring to FIG. 2, reference numeral 201 denotes a image input device; 202, a position/posture sensor; 203, a moving device; 204, a distance sensor; 205, a image input device; 206, a position/posture sensor; 207, a moving device; 208, a distance sensor; 209, an HMD; 210, a position/posture sensor; 211, a performer (who wears the HMD); 212, a CG character; and 213 and 214, virtual objects.

The image input device 201 and distance sensor 204 are attached to the moving device 203. Also, the position/posture sensor 202 is attached to the image input device 201. The moving device 203 is a self-running robot which mounts a battery, and can move around the image input site in arbitrary directions, since it is remote-controlled via wireless communications. Since the moving device 203 has a support base of the image input device 201, which is rotatable in the horizontal and vertical directions, it can freely change the posture of the image input device 201.

As the distance sensor 204, a compact infrared ray sensor, ultrasonic sensor, or the like may be used. If such sensor is used, the distance to an object, which is present within a given range in front of the sensor, can be measured.

In FIG. 2, since the moving device 203 is vertically elongated, two distance sensors 204 (one each on upper and lower front portions) are attached to the front portion of the moving device 203 to broaden the distance measurement range vertically. With this arrangement, since the distance to an object, which is present in front of the moving device 203 and image input device 201, can be measured, the moving device can move while dodging an obstacle and person, and can approach their neighbors, as described in FIG. 1.

The image input device 205, position/posture sensor 206, moving device 207, and distance sensor 208 respectively have the same functions as the image input device 201, position/posture sensor 202, moving device 203, and distance sensor 204 mentioned above.

In this case, the moving device 207 is attached to the ceiling of a building or a support member such as a crane or the like, and can freely change the position and posture of the image input device 205 within a predetermined range.

Note that the moving devices 203 and 207 are not limited to the illustrated examples. In addition, moving devices having various functions and forms such as remote-controllable flying objects (airplane, helicopter, balloon, and the like), waterborne objects (boat, Hovercraft, amphibian, or the like), underwater moving objects (submarine, underwater robot, and the like), and so forth may be used.

The position/posture sensor 210 is attached to the HMD 209, and can measure the viewpoint position and line-of-sight direction of the performer (who wears the HMD) 211. Also, the position/posture sensor 210 is attached to a hand of the performer 211, and can measure the position and direction of the hand of the hand of the performer 211.

The CG character 212 is virtually laid out in a real world to have a position and size that can cover the image input device 201, position/posture sensor 202, moving device 203, and distance sensor 204 (a set of these devices will be referred to as image input device group A hereinafter), so that image input device group A cannot be seen in a composite image from the viewpoints of the image input devices 201 and 205, and the CG character 212 alone can be seen. Also, in a CG image from the viewpoint of the HMD 209, the CG character 212 is displayed at a position where it covers image input device group A.

The virtual object 213 is virtually laid out in a real world to have a position and size that can cover the image input device 205, position/posture sensor 206, image input device 207, and distance sensor 208 (a set of these devices will be referred to as image input device group B hereinafter), so that image input device group B cannot be seen in a composite image from the viewpoints of the image input devices 201 and 205, and the virtual object 213 alone can be seen. Also, in a CG image from the viewpoint of the HMD 209, the CG character 212 is displayed at a position where it covers image input device group B.

The virtual object 214 is displayed at a position where it looks as if it is held by the hand of the performer 211. For example, a CG image can be generated in such a manner that when the performer 211 has made a predetermined hand action, the display position of the virtual object 214 moves to a position where the object is supposedly held by the hand of the G character 212. In this case, in order to display the virtual object 214 at a position where it looks as if it is held by the hand of the performer 211, measurement data obtained from the position/posture sensor 210 attached to the hand of the performer 211 can be used.

On the other hand, in order to display the virtual object 214 at a position where it looks as if it is held by the hand of the CG character 212, the CG geometric information described in FIG. 1 can be used.

In FIG. 2, since there are two image input devices, a viewer can selectively watch one of the composite images from the viewpoints of the image input devices 201 and 205. Or when the image display device 114 described in FIG. 1 has a two-split screen display function, the viewer can watch the composite images from the two viewpoints, which are simultaneously displayed on the screen.

The present invention relates to an image processing method and apparatus, which comprise both image input means and CG image generation means to naturally composite a real image and CG image, and can be used to provide novel services to every viewing sites including the image input site and remote places in the fields that exploit images such as shooting and rehearsal of a movie and television program, play, game, KARAOKE, and the like.

### Second Embodiment

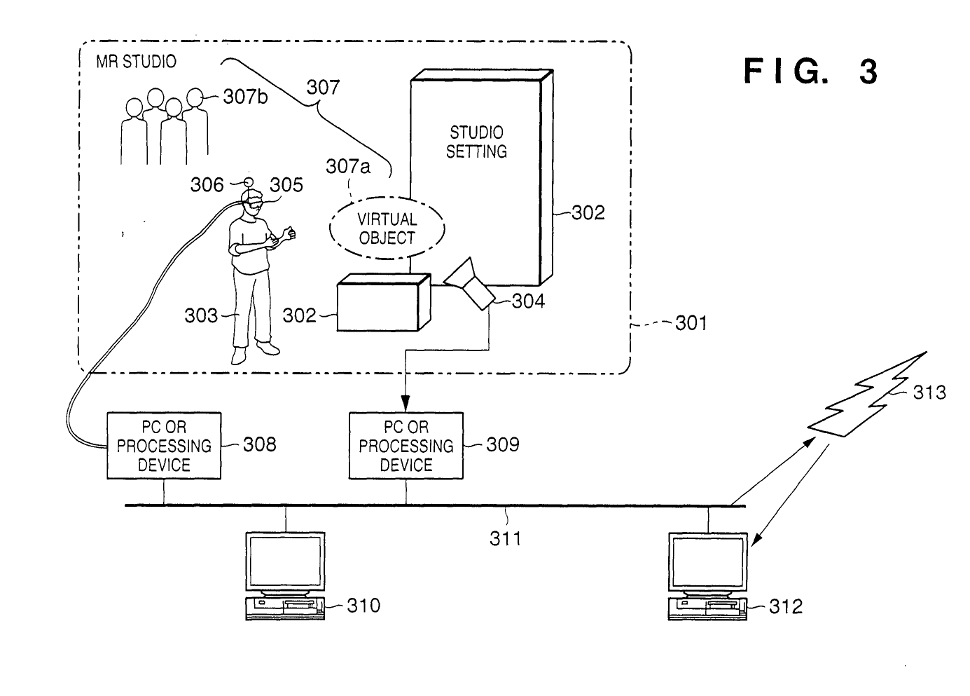

The second embodiment of the present invention will be described below with reference to FIGS. 3 to 15.

FIG. 3 is a block diagram showing the system arrangement of a studio apparatus which comprises an image processing apparatus according to this embodiment.

Referring to FIG. 3, reference numeral 301 denotes a studio (MR studio) serving as a image input site; 302, a studio setting placed in the studio 301; 303, a performer; 304, a image input camera (image input means); 305, a head-mounted display (to be abbreviated as an HMD hereinafter) that the performer 303 wears on his or her head; 306, a position sensor (display parameter acquisition means) built in the HMD 305; 307, virtual objects (307a, a virtual object as a main character upon shooting, and 307b, a virtual object corresponding to viewers) which are superimposed on a image to be observed by the performer 303 and a image taken by the camera 304; 308, a image generation device for generating a image to be observed by the performer 303; 309, a image superimpose device for superimposing a image of the virtual objects 307 on a image taken by the camera 304; 310, an operating device for managing and operating the states of the virtual objects 307; 311, a network for connecting the image generation device 308, image superimpose device 309, and operating device 310; 312, a viewer information management device for managing information of viewers by receiving communications from the viewers; and 313, an interactive broadcast device (transmission device) for transmitting or broadcasting the output from the image superimpose device 309, and receiving information (reactions) from the viewers.

As the position sensor 306, for example, devices such as a magnetic position/direction sensor, Fastrak available from Polhemus Incorporated, and the like may be used. The image generation device 308 or image superimpose device 309 can comprise a combination of a PC (personal computer), a video capture card, and a video card with a CG rendering function. The operating device 310 can comprise a normal PC.

The number of sets of the HMD 305, image generation device 308, and the like can be increased in correspondence with the number of performers or the number of staff members who observe at the same time, and the number of sets of the camera 304, image superimpose device 309, and the like can be increased in correspondence with the number of image input cameras.

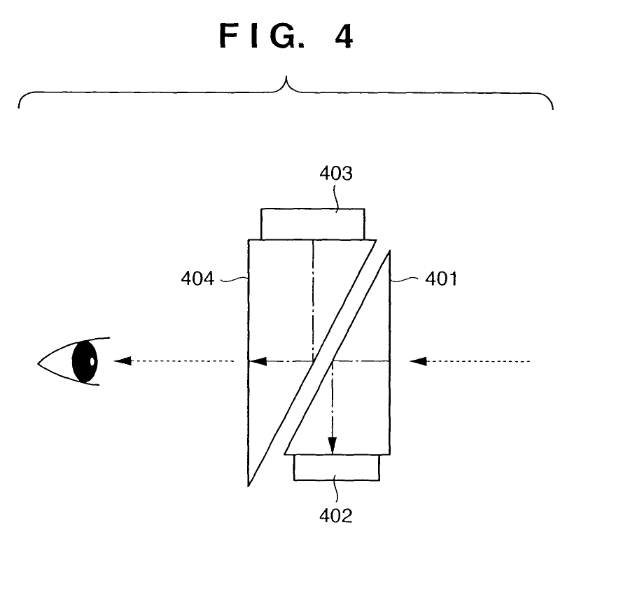

FIG. 4 shows the internal structure of the HMD 305. The HMD 305 comprises a first prism optical element 401 for guiding incoming external light to an image sensor, an image sensing element 402 for receiving and sensing the light, a display element 403 for presenting a image, a second prism optical element 404 for guiding the displayed image to the eye, and the like, since it has functions of both a display device and an image sensing device.

As shown in FIG. 3, the studio setting 302 is placed in the studio 301, and the performer 303 acts in that studio. The performer 303 wears the HMD 305 with the built-in position sensor 306, which outputs the position information. The operating device 310 receives instructions for displaying and moving the virtual objects 307, and transfers these instructions to the image generation device 308 and image superimpose device 309 via the network 311.

The image generation device 308 generates a CG image in correspondence with the instructed states of the virtual objects 307 and the head position information obtained from the position sensor 306 or the like, composites it with sensed image data obtained from the HMD 305, and outputs the composite image to the HMD 305. By watching the composite image displayed on the HMD 305, the performer 303 can observe the virtual objects 307 as if they were present in the studio setting 302. The camera 304 senses the state of the studio 301 including the performer 303 and studio setting 302, and outputs the sensed image data. The image superimpose device 309 generates a CG image corresponding to the state of the virtual objects 307 according to an instruction from the operating device 310, and the position and posture of the camera 304, and composites that image with image data obtained from the camera 304, thus generating an output image.

The image generated by the image generation device 308 and image superimpose device 309 is not only watched by a player in the studio 301 but also broadcasted to viewers via the interactive broadcast device 313.

The interactive broadcast device 313 comprises the Internet and BS digital broadcast, which are building components which are known to those who are skilled in the art. More specifically, as for BS digital broadcast, downstream video distribution (from the studio to home) is made via a satellite, and upstream communications are made via the Internet using a cable, telephone line, or dedicated line. If the Internet allows a broadband communication, downstream video distribution can also be made via the Internet. The studio and home are interconnected via these upstream and downstream communications.

At this time, information in response to broadcast contents, which is sent from each viewer (home) is received and managed by the viewer information management device 312.

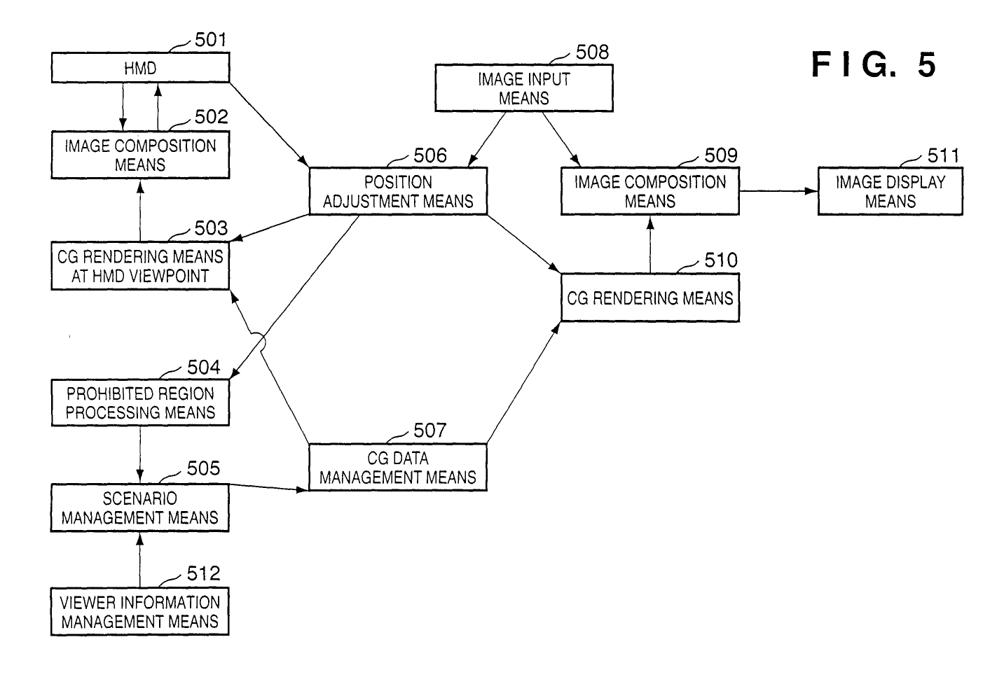

FIG. 5 is a block diagram showing details of the operation of the image processing apparatus according to this embodiment shown in FIG. 3.

Referring to FIG. 5, reference numeral 501 denotes an HMD which has a so-called see-through function, and comprises an image sensing unit and image display unit. Reference numeral 502 denotes a first image composition means; 503, a first CG rendering means that renders a CG image from the viewpoint of the HMD 501; 504, a prohibited region processing means controls the existence range of a CG object; 505, a scenario management means; 506, a position adjustment means including a position sensor and the like; 507, a CG data management means; 508, a image input means such as a camera or the like; 509, a second image composition means; 510, a second CG rendering means that renders a CG image from the viewpoint of the image input means 508; 511, an image display means; and 512, a viewer information management means.

An image sensed by the HMD 501 is composited with a CG image generated by the first CG rendering means 503 by the first image composition means 502, and that composite image is displayed on the HMD 501. An image sensed by the HMD 501 is also sent to the position adjustment means 506, which calculates the position/direction of the HMD (i.e., the head) on the basis of that information and tracking information obtained from a position sensor or the like, and sends the calculated information to the first CG rendering means 503.

The first CG rendering means 503 renders a CG image from the viewpoint of the HMD 501 on the basis of the position/direction information of the head obtained by the position adjustment means 506 and CG data obtained from the CG data management means 507. The scenario management means 505 sends information required for a scene configuration to the CG data management means 507 in accordance with information obtained from the prohibited region processing means 504, the progress of a rehearsal or action or operator's instructions, and the like.

The CG data management means 507 instructs the first or second CG rendering means 503 or 510 to render CG data in accordance with the received information. The same applies to a process for an image obtained by the image input means 508. That is, an image sensed by the image input means 508 is composited with a CG image generated by the second CG rendering means 510 by the second image composition means 509, and the obtained composite image is displayed on the image display means 511. An image sensed by the image input means 508 is also sent to the position adjustment means 506, which calculates the position/direction of the image input means (i.e., a camera) on the basis of that information and tracking information obtained from a position sensor or the like, and sends the calculated information to the second CG rendering means 510.

The second CG rendering means 510 renders a CG image from the viewpoint of the image input means 508 on the basis of the position/direction information of the image input means 508 obtained by the position adjustment means 506 and CG data obtained from the CG data management means 507. The position adjustment means 506 sends the calculated position/direction data of the HMD (i.e., the head) and the position/direction data of the image input means (i.e., the camera) 508 to the prohibited region processing means 504. The prohibited region processing means 504 corrects the position of the CG object based on these data in accordance with the range where the CG object is to exist.

Information required for CG rendering, which is managed by the scenario management means 505, is information that can manage the state of a virtual world around the player in correspondence with each scene and progress of a scenario. More specifically, that information includes the number of a CG model to be displayed, reference position/posture data, the number indicating the type of action, parameters associated with the action, and the like for each individual character to be displayed.

The scenario is managed for each scene, and the aforementioned data set is selected in accordance with the status values of each character such as characteristics, state, and the like, the action of the performer, and the like in each scene. Furthermore, character information (number, positions, states) of viewer is managed as a portion of a CG environment around the player. The characters of viewer depend on information sent from the viewer information management means 512 independently of the progress of a scenario.

Note that the see-through function of the HMD 501 can also be implemented by arranging the HMD to allow the user to see through the external field (optical see-through scheme). In this case, the aforementioned first image composition means 502 is omitted.

The position adjustment means 506 may comprise means that detects a 3D position/posture such as a mechanical encoder or the like, the aforementioned magnetic position sensor, or optical position adjustment means or that using image recognition or the like. The position adjustment of the image input means 508 and that of the HMD 501 may be done by independent position adjustment means.

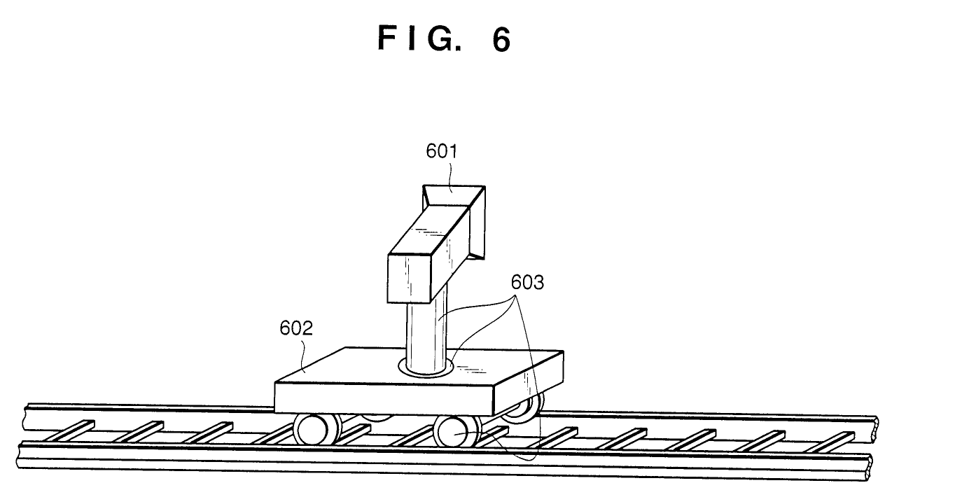

FIG. 6 shows an example of a camera device using a mechanical encoder. Referring to FIG. 6, reference numeral 601 denotes a camera; 602, a dolly that carries the camera 601; and 603, a measurement device such as a rotary encoder or the like, which is provided to each joint. The measurement device 603 can measure and output the position and direction of the camera 601 from the position of the dolly 602.

Note that the output from the second image composition means 509 in FIG. 5 can be displayed on a viewfinder of the camera 601. In this manner, the cameraman can make camerawork in correspondence with a virtual world.

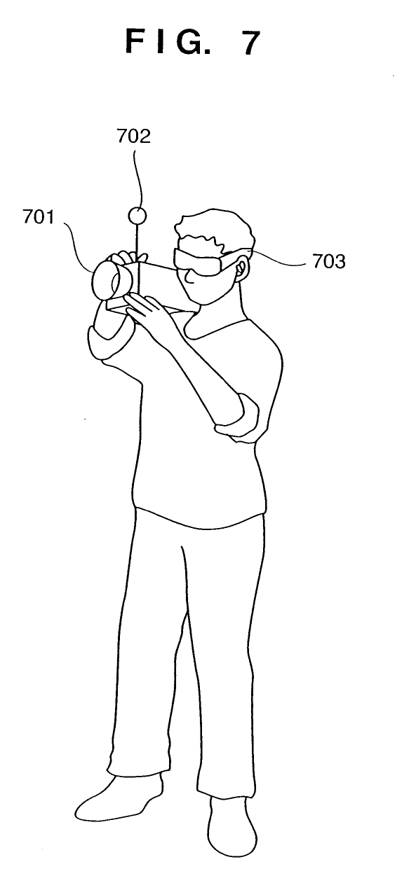

FIG. 7 shows an example of a hand-held camera device that uses a magnetic position/direction sensor.

Referring to FIG. 7, reference numeral 701 denotes a camera to which a magnetic receiver (measurement device) 702 is fixed. The 3D position and direction of the camera 701 are calculated based on the magnetic state measured by the receiver 702. For example, Fastrak available from Polhemus Incorporated mentioned above can be used for this purpose.

Reference numeral 703 denotes an HMD, the position and direction of which are calculated by the same method as the camera 701. In case of such hand-held camera device, a cameraman wears an HMD 703 (or its single-eye version), and the output from the image composition means is displayed on the HMD 703, thus allowing camerawork in correspondence with a virtual world.

In case of a camera device with a zoom function, zoom information of a zoom lens is sent to an external processing apparatus. Furthermore, whether or not viewer information is superimposed and displayed on the camera device can be selected by the cameraman as needed.

The CG data management means 507 in FIG. 5 records 3D CG models, animation data, and image data of real images and the like, e.g., 3D animation data of a CG character. The CG data management means 507 selects a CG model or animation to be displayed in accordance with the number of a CG model, the reference position/posture data, the number indicating the type of action, parameters associated with the action, and the like for each character, which are received from the scenario management means 505, and sets parameters of the position, posture, and the like of the selected CG model, thus changing a scene graph used in CG rendering.

The scenario management means 505 stores information such as a script, lines, comments, and the like required to help actions, and lays out viewer characters on an auditorium in accordance with the states of viewers obtained from the viewer information management means. The means 505 sends required information to the CG data management means 507 in accordance with each scene. The CG data management means 507 instructs the CG rendering means 503 and 510 to execute a rendering process according to such information.

Each scene progresses using an arbitrary user interface (mouse, keyboard, voice input, or the like).

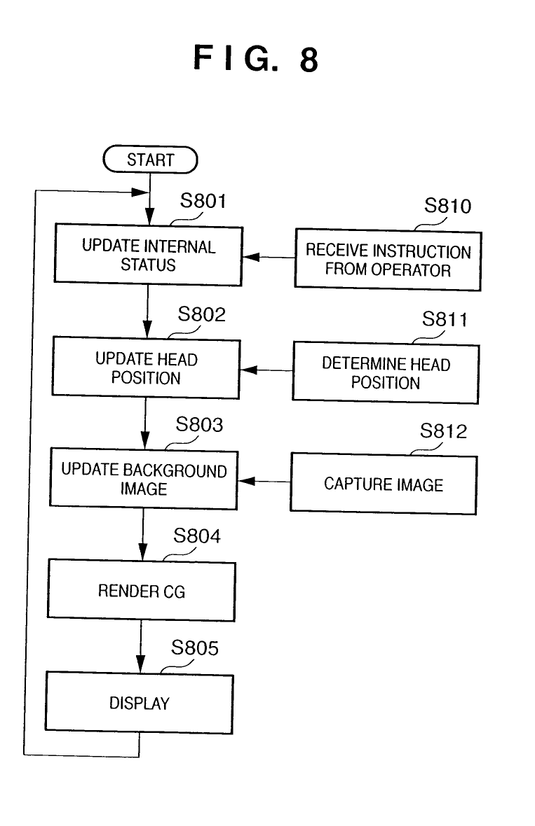

The operation for generating a image to be displayed on the HMD 305 that the performer 303 wears in FIG. 3 will be described below using FIGS. 3 and 8.

FIG. 8 is a flow chart showing the flow of the operation for generating a image to be displayed on the HMD 305 that the performer 303 wears in FIG. 3. In FIG. 8, steps S810 to S812 are implemented by threads, which run independently and parallelly, using a parallel processing program technique, which is widespread in the art in recent years.

Once the process shown in FIG. 8 starts, it runs as an infinite loop until it is interrupted, and another process starts after interrupt.

A process in the image generation device 308 executes an internal status update process as a process for updating status flags (the type, position, and status of an object to be displayed) for rendering a CG in accordance with an instruction obtained from the operating device 310 (step S801). Head position information obtained by a head position determination process (to be described later) is fetched (step S802). The latest image obtained from the video capture card is captured as a background image (step S803). CG data is updated on the background image in accordance with the internal status data set in step S801, and a CG is rendered to have the head position set in step S802 as the position of a virtual camera used in CG generation (step S804). Finally, a CG command for displaying a composite image as the rendering result is supplied to the video card, thus displaying the composite image on the HMD (step S805). After that, the flow returns to step S801.

Note that step S810 is a thread for receiving instruction data from the operating device 310 via the network 311. Step S811 is a thread for receiving information from the position sensor 306 and determining the head position using the received information and image data obtained from the video capture card together. Furthermore, step S812 is an image capture thread for periodically reading out image data from the video capture card.

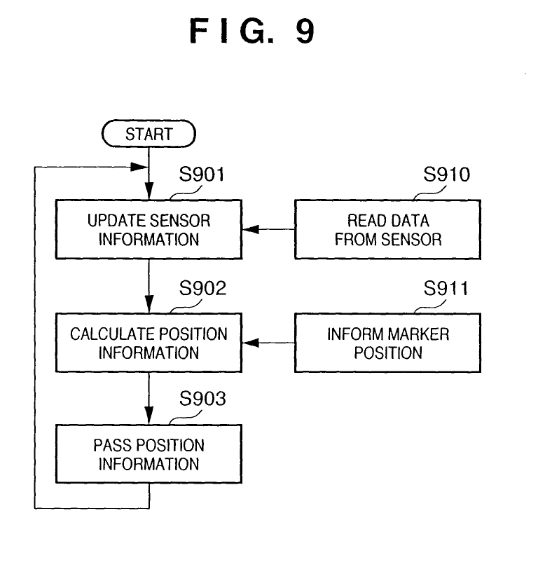

The head position determination operation will be described below using FIGS. 3 and 9.

FIG. 9 is a flow chart showing the flow of the head position determination operation. In FIG. 9, step S910 is a thread for reading data from the sensor, and step S911 is a thread for receiving a marker position message.

Note that data from the position sensor 306 is a data communication to a normal RS232C port, and data at that port is periodically read out in step S910. The message in step S911 is sent using a general network communication protocol (TCP-IP).

Once the process shown in FIG. 9 starts, it runs as an infinite loop until it is interrupted, and another process starts after interrupt.

The image generation device 308 updates the head position to a position corresponding to the latest position information obtained from the position sensor 306 (step S901). Then, a specific marker image is recognized from image data obtained by the camera of the HMD 305 to acquire correction information of the head position, and direction data of the head is updated in accordance with the correction information (step S902). Finally, the obtained position data (including direction) of the head is passed to step S811 as the head position determination thread (step S903). After that, the flow returns to step S901.

The head direction is corrected as follows. That is, a predicted value (x0, y0) which indicates the position of a marker in an image is calculated based on the 3D position and direction of the head (viewpoint) in a world coordinate system, which are obtained from the position sensor 306, and the 3D position of the marker. A motion vector from this predicted value (x0, y0) to the actual marker position (x1, y1) in the image is calculated. Finally, a value obtained by rotating the direction of the head through an angle that looks in this vector as a correction value is output as the direction of the HMD 305.

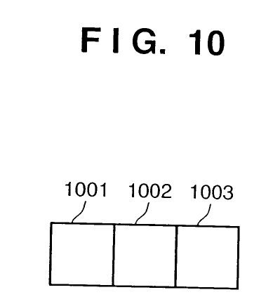

FIG. 10 shows an example of the marker adhered in the studio 301 for position measurement. A monochrome marker may be used. However, this embodiment uses a marker having three rectangular color slips 1001, 1002, and 1003 with a specific size, which are laid out to have a specific positional relationship. For respective color slips 1001, 1002, and 1003, arbitrary colors can be selected. Using such marker, a large number of types of markers can be stably detected.

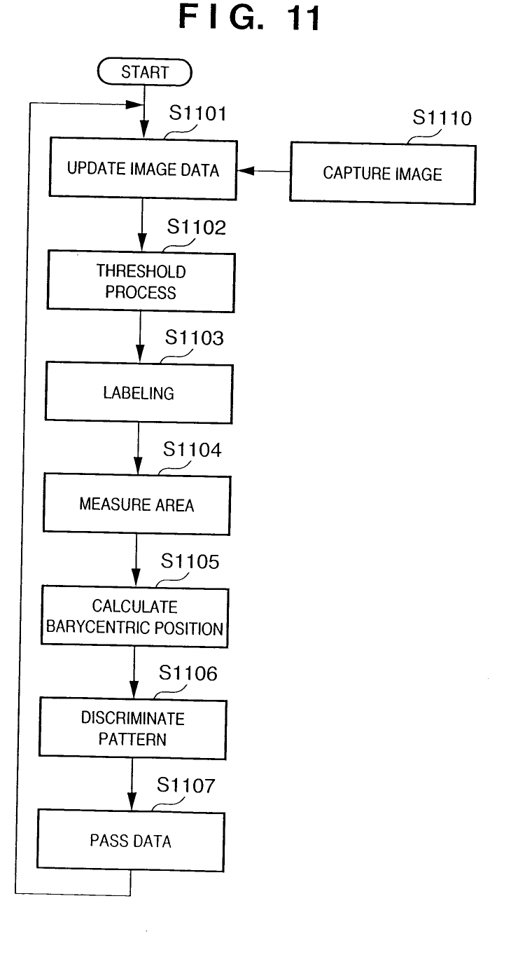

The marker position determination operation will be described below using FIGS. 3 and 11.

FIG. 11 is a flow chart showing the flow of the marker position determination operation. In FIG. 11, step S1110 is a thread for obtaining image data which is to undergo image recognition, i.e., a thread for periodically reading out an image from the image capture card.

Once the process shown in FIG. 11 starts, it runs as an infinite loop until it is interrupted, and another process starts after interrupt.

The image generation device 308 or image superimpose device 309 updates image data to the latest one (step S1101). Then, the device 308 or 309 executes a threshold process of the image using some pieces of color information used to discriminate the registered marker (step S1102). Then, the device 308 or 309 couples obtained binary images and executes their labeling process (step S1103). The device 308 or 309 counts the areas of respective label regions (step S1104), and calculates the barycentric position (step S1105). It is checked based on the relationship between the label areas and the barycentric position between labels if the image matches the registered mark pattern (step S1106). Finally, the barycentric position of the central label that matches the image is output as the marker position (step S1107). After that, the flow returns to step S1101.

The marker position information output in step S1107 is used to correct the direction of the HMD 305 or camera 304. By setting information of the position and direction of the HMD 305 or camera 304 as those of the virtual camera upon CG rendering, a CG image which is aligned to the real world is generated.

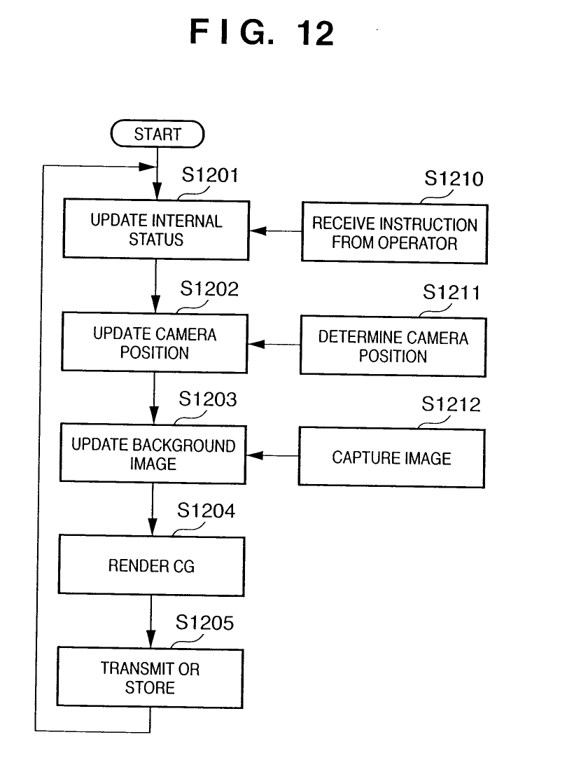

The image processing operation of the image superimpose device 309 will be explained below using FIGS. 3 and 12.

FIG. 12 is a flow chart showing the flow of the image superimpose device 309. In FIG. 12, steps S1210 to S1212 are implemented by threads, which run independently and parallelly, using a parallel processing program technique, which is widespread in the corresponding field in recent years.

Once the process shown in FIG. 12 starts, it runs as an infinite loop until it is interrupted, and another process starts after interrupt.

A process in the image superimpose device 309 executes an internal status update process as a process for updating status flags (the type, position, and status of an object to be displayed) for rendering a CG) in accordance with an instruction obtained from the operating device 310 (step S1201). Camera position information obtained from a camera position determination process is fetched (step S1202). The latest image obtained by the image capture process using the video capture card is captured as a background image (step S1203). CG data is updated on the background image in accordance with the internal status data set in step S1201, and a CG is rendered to have the camera position set in step S1202 as the position of a virtual camera used in CG generation (step S1204). Finally, a CG command for displaying a composite image as the rendering result is supplied to the video card, thus displaying the composite image on the HMD 305 (step S1205). After that, the flow returns to step S1201.

Note that step S1210 is a thread for receiving instruction data from the operator apparatus via the network 311. Step S1211 is a thread for receiving information from the camera device shown in FIG. 6 or 7, and determining the camera position using the received information and image data obtained from the video capture card together. Furthermore, step S1212 is an image capture thread for periodically reading out image data from the video capture card.

In this embodiment, a real-time composite image as the output from the image generation device 308 or image superimpose device 309 is used as the output of the overall apparatus.

Hardware which forms the image generation device 308 or image superimpose device 309 can be implemented by combining a general computer and peripheral devices.

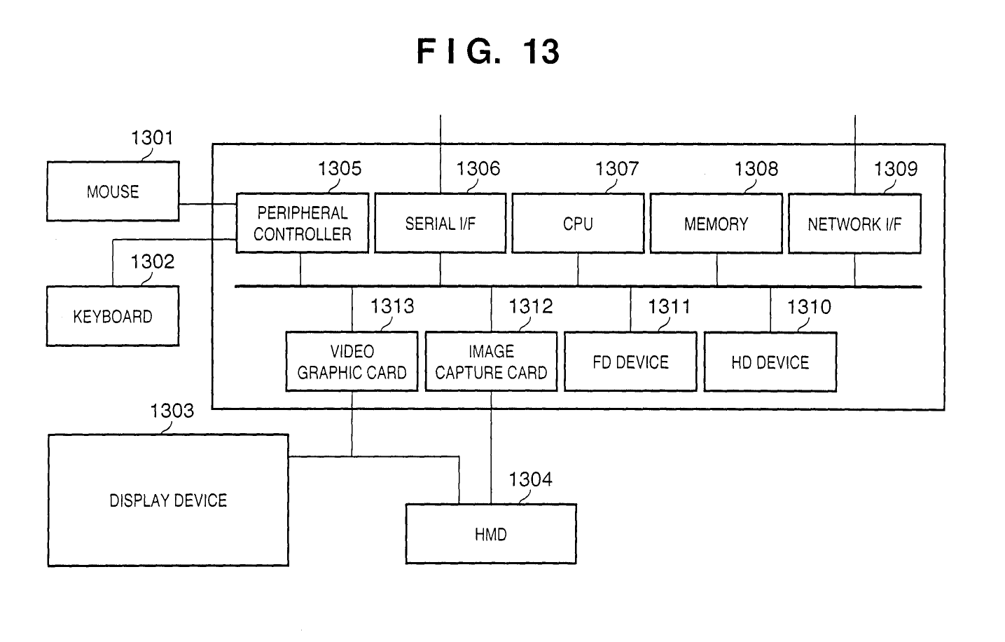

FIG. 13 is a block diagram showing an example of the hardware arrangement of the image generation device 308. Referring to FIG. 13, reference numeral 1301 denotes a mouse serving as an input means; 1302, a keyboard also serving as the input means; 1303, a display device for displaying an image; 1304, an HMD for displaying and sensing an image; 1305, a peripheral controller; 1306, a serial interface (I/F) for exchanging information with a position sensor; 1307, a CPU (central processing unit) for executing various processes based on programs; 1308, a memory; 1309, a network interface (I/F); 1310, a hard disk (HD) device used to load a program from a storage medium; 1311, a floppy disk (FD) device used to load a program from a storage medium; 1312, an image capture card; and 1313, a video graphic card.

In case of the image superimpose device 309, an input is received from the image input device (camera) in place of that from the HMD 1304, and a image signal is output to the display device 1303 as an image display device. In case of the operating device 310, the HMD 1304 and image capture card 1312 can be omitted.

The programs which implement this embodiment can be loaded from a program storage medium via the FD device, a network, or the like.

In the home of each end viewer of the interactive broadcast device 313, the broadcast is received using an Internet terminal that can establish connection to the Internet, or a BS digital broadcast terminal or digital television (TV) terminal. At the same time, such terminal can communicate with the viewer information management device 312 when it establishes connection to the Internet. The viewer can see the broadcasted image, and can make operation such as clicking on a specific position on the screen by a general interactive means using a mouse, remote controller, or the like.

Such viewer's operation is sent as data from the Internet terminal or the like to the viewer information management device 312, which records or counts such data to collect reactions from the viewers. In this case, cheering or booing with respect to the broadcast contents (match contents in case of a game) is collected by counting key inputs or clicks from viewers. The count information is transferred to the operating device 310, which appends viewer information to a scenario which is in progress in accordance with that information, and manipulates the action of a CG character, parameters upon progressing a game, a CG display pattern, and the like in accordance with the information. For example, when many booing data are collected from viewer, booing from virtual viewer is reflected in a image, and stirs up a player. Also, as for a cameraman, such booing can be considered as that for a camera angle, and the cameraman can seek an angle that viewers want to see.

The viewer information management device 312 has the same arrangement as a server device generally known as a Web server. More specifically, the viewer information management device 312 accepts an input from a terminal, which serves as a client, as a server side script using CGI, Java, or the like. The processing result is managed using an ID (identifier) and information as in a database.

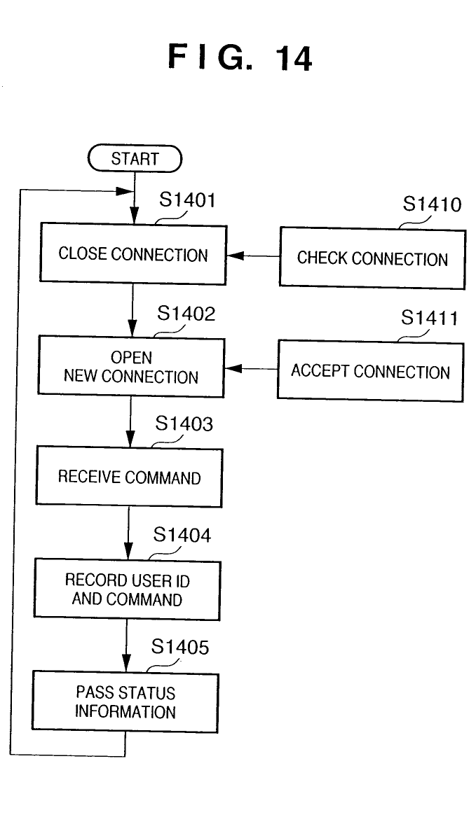

The processing operation of the viewer information management device 312 will be described below using FIG. 14.

FIG. 14 is a flow chart showing the flow of the processing operation of the viewer information management device 312. Referring to FIG. 14, step S1410 as a connection check process that holds connection via the network, and step S1411 as a new connection reception process are programmed to run parallelly as threads independent from the flow of the main processing.

Once the process shown in FIG. 14 starts, it runs as an infinite loop until it is interrupted, and another process starts after interrupt.

The viewer information management device 312 receives the status data of the currently established connections from step S1410 as the connection check process, and closes connection for cleaning up internal status data (step S1401) if connection is disconnected. A new connection request is received from step S1411 as the connection reception process, and if a new connection request is detected, new connection is established (opened) (step S1402). Then, commands are received from all connections (step S1403). Various kinds of commands are available, and the command format in this case is [StatusN], where N is a number indicating status data of viewer's choice. This number may be the number of a key-pad pressed by the viewer, the number of each divided region of the screen, and the like according to setups. The ID of the connected user and command N are recorded (step S1404). Then, the device 312 passes status information of all users (step S1405). After that, the flow returns to step S1401.

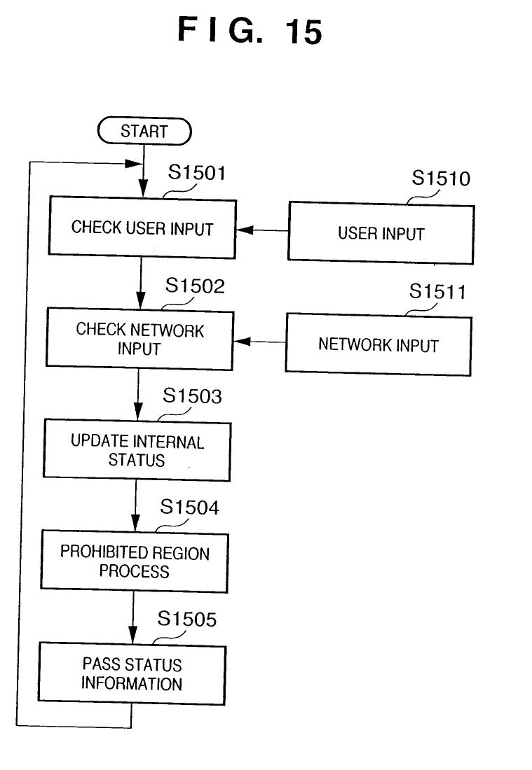

The processing operation of the operating device 310 corresponding to the viewer information management device 312 will be described below using FIG. 15.

FIG. 15 is a flow chart showing the flow of the processing operation of the operating device 310 corresponding to the viewer information management device 312. Once the process shown in FIG. 15 starts, it runs as an infinite loop until it is interrupted, and another process starts after interrupt.

The operating device 310 receives user's operation input from step S1510 as a user input process (step S1501). The operating device 310 then receives status information of respective viewers from the viewer information management device 312 from step S1511 as a network input process by a communication via the network (step S1502). The operating device 310 updates internal status values (scenario progress pointer, display mode, and the like) in accordance with the status information of respective viewers (step S1503). In this case, the number and states (cheer, enjoy, boo, or the like) of viewer displayed as virtual objects, which are managed by the scenario management means 505 (see FIG. 5) are updated in accordance with the number of connected viewers. The prohibited region is determined based on the position information of the camera 304 and performer 303, and the position data is updated to inhibit a virtual CG object from entering this region (step S1504). The status information updated in step S1504 is sent to the image generation device 308 and image superimpose device 309 (step S1505). After that, the flow returns to step S1501.

As described above, user's input operation can be made using an input device such as the mouse 1301, keyboard 1302, or the like shown in FIG. 13 or via a voice input, gesture command, or the like.

Note that the prohibited region process limits an the region of a CG object to a desired region to prevent an occlusion conflict between a virtual CG object and real object. In occlusion management, in case of a stationary real object, a CG object is set in advance to have the same shape and position/direction of the real object, a real image is used on the region of the CG object corresponding to the real object, and upon rendering a virtual object, an occlusion surface process with a CG object corresponding to the set real object is executed, thus correctly processing occlusion between the real object and virtual CG object.

As described above, according to the image processing apparatus of this embodiment, a composite image of a real image, CG, and the like in real time can be experienced. Also, in the studio apparatus (studio system) that can make interactive broadcast, since reactions from viewers in remote places are composited as virtual viewer (characters), new image experience in which the player and cameraman in the studio can feel the presence of viewers, and the viewers can participate can be implemented.

That is, the HMD, measurement means that measures the position and direction, and image composition means that composites images are arranged in the studio to allow a performer to act while observing the image composited by the image composition means, and to allow end viewers to manipulate virtual characters as CG images to be directly composited via the Internet, thus providing new image experience to both the users in remote places and the studio.

More specifically, since an image to be composited, which cannot be seen by the performer so far can be seen by the performer during action, unnatural actions can be avoided, or the degree of freedom in action can be improved.

Also, since the performer can directly see virtual characters, he or she can simultaneously experience a state in which home viewers participate via the Internet, thus allowing interactions between the home and studio.

### Third Embodiment

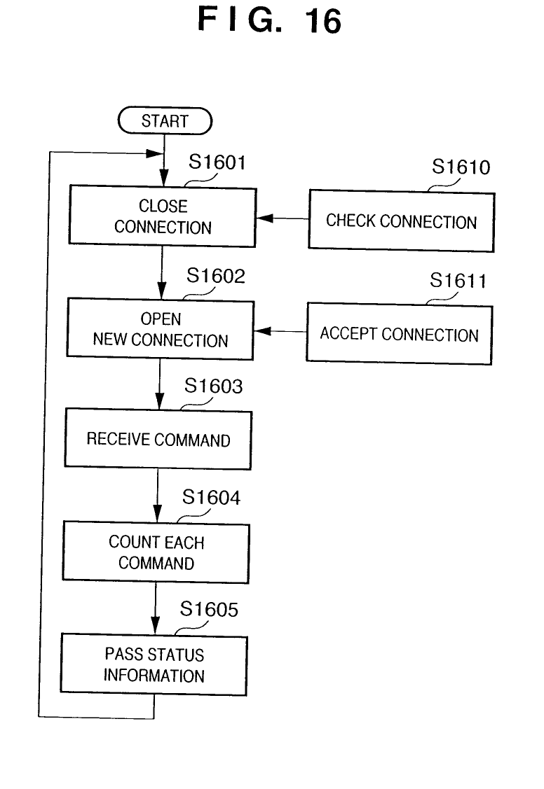

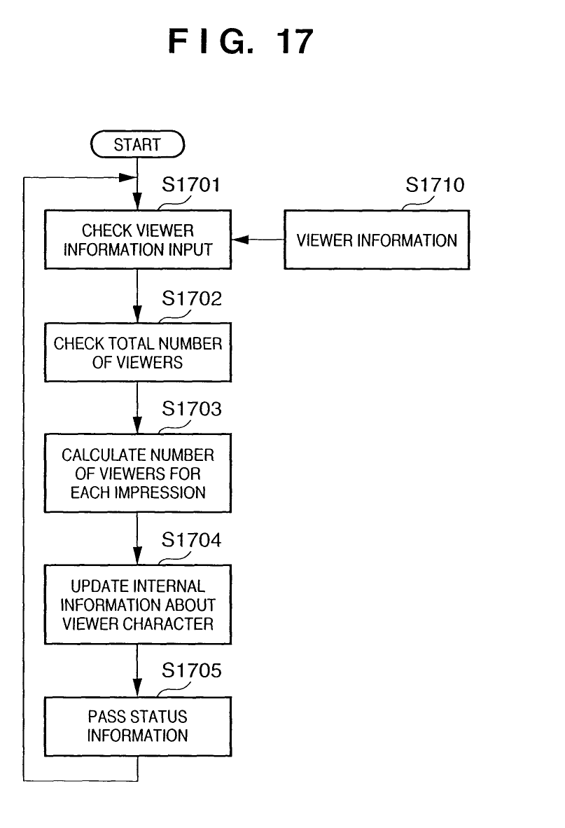

The third embodiment of the present invention will be described below with reference to FIGS. 16 and 17.

Since the system arrangements of an image processing apparatus of this embodiment and a studio apparatus that comprises the image processing apparatus are the same as those in the second embodiment mentioned above, the following explanation will be given while quoting the drawings in the second embodiment as needed.

This embodiment relates to a method of coping with a case wherein the number of viewers is large in a system for displaying reactions of viewers as virtual viewer characters on a player in a studio and a broadcast image as in the second embodiment.

In the second embodiment, reactions of viewers are composited and displayed as viewer characters. For this reason, when the number of viewers is large, problems of management of models and states of viewer CG characters and the layout positions of viewer CG characters are posed, and the ambience of the entire scene may impair due to too large a number of viewer CG characters. Hence, an area (virtual auditorium) for displaying viewer CG characters is set, and information from viewers is counted and displayed in correspondence with the auditorium size.

The processing operation of the viewer information management device 312 in the image processing apparatus of this embodiment will be described below using FIG. 16.

FIG. 16 is a flow chart showing the flow of the processing operation of the viewer information management device 312 in the image processing apparatus of this embodiment. Referring to FIG. 16, step S1610 as a connection check process that holds connection via the network, and step S1611 as a new connection reception process are programmed to run parallelly as threads independent from the flow of the main processing.

Once the process shown in FIG. 16 starts, it runs as an infinite loop until it is interrupted, and another process starts after interrupt.

The viewer information management device 312 receives the status data of the currently established connections from step S1610 as the connection check process, and closes connection for cleaning up internal status data (step S1601) if connection is disconnected. A new connection request is received from step S1611 as the connection reception process, and if a new connection request is detected, new connection is established (opened) (step S1602). Then, commands are received from all connections (step S1603). Various kinds of commands are available, and the command format in this case is [StatusN], where N is a number indicating status data of viewer's choice. This number may be the number of a key-pad pressed by the viewer, the number of each divided region of the screen, and the like according to setups. These commands are counted for each N (step S1604). Then, the device 312 passes the count value for each N as status information (step S1605). After that, the flow returns to step S1601.

In case of impressions (cheering, booing, normal) from viewers to scene or game contents, there are three levels of viewer states, and status information is passed in step S1605 in FIG. 16 as the ratios of the numbers of viewers of respective states to the total number of viewers.

The flow of the processing operation of the operating device 310 in the image processing apparatus of this embodiment is substantially the same as that in FIG. 15 in the second embodiment, except that count values in step S1604 in FIG. 16 are input via the network in step S1511. In step S1503, the internal status update process is executed. In this case, since information to be updated includes the ratios of the numbers of viewers of respective states (cheering, booing, normal) to the total number of viewers, and the numbers and positions of viewer CG characters to be displayed are not determined, they are determined in step S1503. More specifically, such process is done by the scenario management means 505 in FIG. 5.

The scenario management means 505 lays out viewer CG characters of respective states (cheering, booing, normal) so that the ratios of seats match the values input in step S1502. In this manner, the information about viewer characters which represent viewer states can be updated to fall within a range set as the virtual (CG) auditorium. After that, position data is updated (step S1504), and the updated status information is sent to the image generation device 308 and image superimpose device 309 (step S1505).

Details of the process for setting viewer CG characters based on viewer information in this embodiment are executed by the scenario management means 505 in FIG. 5. The scenario management means 505 manages all worlds (situations) to be composited as CG data, and sets viewer CG characters based on the ratios of the count values of impressions to the total viewer count in place of impressions themselves as viewer information.

The viewer CG character setting processing operation executed in the scenario management means 505 in the image processing apparatus of this embodiment will be described below with reference to FIG. 17.

FIG. 17 is a flow chart showing the flow of the viewer CG character setting processing operation executed in the scenario management means 505 in the image processing apparatus of this embodiment.

Once the process shown in FIG. 17 starts, it runs as an infinite loop until it is interrupted, and another process starts after interrupt.

It is checked first if viewer information is input from step S1710 (step S1701). If viewer information is input, the flow advances to the next step. Note that the viewer information includes the ratios of impressions of viewers with respect to the current scene and the total number of viewers, which are passed in step S1605 in FIG. 16. It is then checked if the total number of viewers is smaller than the number of people that can fall within a prepared CG viewer area (step S1702). In this case, the maximum capacity set as the CG viewer area is compared with the total number of viewers input in step S1701. If the total number of viewers is larger than the maximum capacity, the total number of viewers is set as the maximum capacity.

The numbers of characters corresponding to impressions (e.g., cheering, booing, normal) with respect to the scene are counted (step S1703). This calculation is made by the total number of viewers×the impression ratios. Internal information under management is updated so that viewer CG characters are laid out in the auditorium area in correspondence with the numbers of characters calculated in step S1703 (step S1704).

Note that the viewer layout method has many variations. For example, characters having the same impression may be laid out together in a given area, or may be randomly distributed. After that, upon completion of update of another internal information in the scenario management means 505, information is passed (step S1705). After that, the flow returns to step S1701.

As described above, according to the image processing apparatus of this embodiment, even when the number of viewers is huge, a image of viewer CG characters as the sum totals of opinions of the entire viewers is composited. Also, since the number of CG characters to be managed depends on the maximum capacity of the auditorium area, the load on the entire system can be reduced.

### Fourth Embodiment

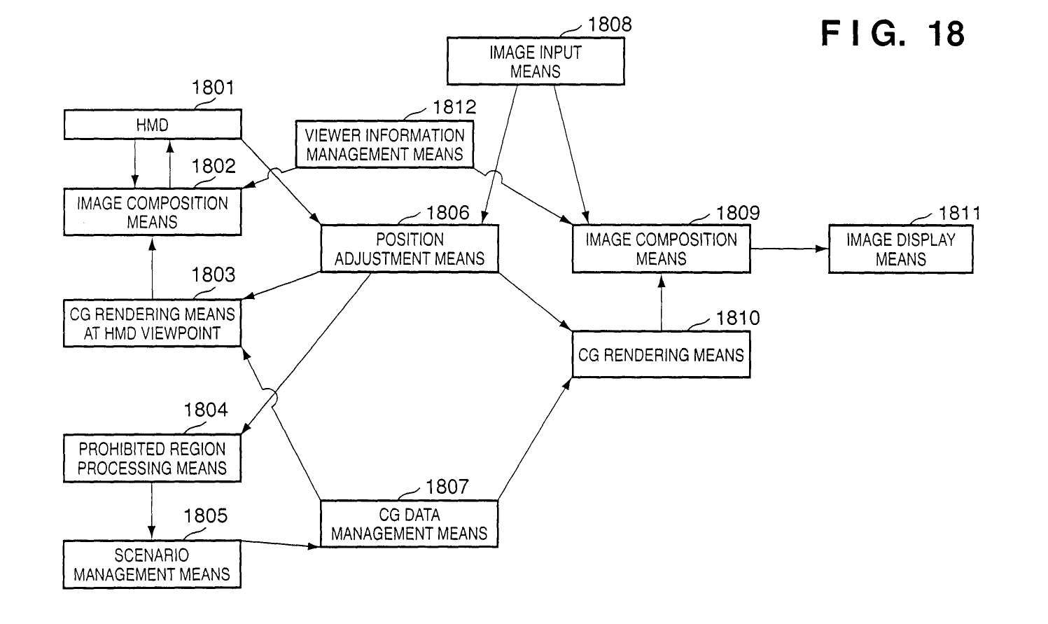

The fourth embodiment of the present invention will be described below with reference to FIG. 18.

Since the system arrangements of an image processing apparatus of this embodiment and a studio apparatus that comprises the image processing apparatus are the same as those in the second embodiment mentioned above, the following explanation will be given while quoting the drawings in the second embodiment as needed.

This embodiment displays viewers information to the entire system, cameraman, director, and the like via viewer CG character in the third embodiment mentioned above. Conversely, unlike in the second and third embodiments described above, a viewer himself or herself cannot see what other viewers feel as a image.

The overall arrangement in this embodiment is the same as that in FIG. 3 in the second embodiment. However, no virtual viewer 307b is displayed.

FIG. 18 is a block diagram showing the details of the operation of the image processing apparatus of this embodiment shown in FIG. 3.

Referring to FIG. 18, reference numeral 1801 denotes an HMD which has a so-called see-through function, and comprises an image sensing unit and image display unit. Reference numeral 1802 denotes a first image composition means; 1803, a first CG rendering means that renders a CG image from the viewpoint of the HMD 1801; 1804, a prohibited region processing means that controls the range of a CG object; 1805, a scenario management means; 1806, a position adjustment means including a position sensor and the like; 1807, a CG data management means; 1808, a image input means such as a camera or the like; 1809, a second image composition means; 1810, a second CG rendering means that renders a CG image from the viewpoint of the image input means 1808; 1811, an image display means; and 1812, a viewer information management means.

In the second and third embodiments described above, the HMD 501 and image display means 511 display images obtained by compositing/superimposing a real image and CG image by the image composition means 502 and 509.

By contrast, in this embodiment, each of the image composition means 1802 and 1809 composites images so that count data of impressions of viewers sent from the viewer information management means 1812 (data passed in step S1605 in FIG. 16 in the third embodiment) are displayed overlaid on a composite image of a real image and CG image (or on the edge of the screen).

In the above embodiments, viewer information cannot be seen unless a player or cameraman watches an information display portion via viewer CG characters. However, according to this embodiment, viewer information is always displayed on the screen irrespective of the camera angle.

However, this viewer information is effective for the player and cameraman, but may disturb a image for end viewers. Hence, the image composition means 1802 and 1809 do not composite viewer information on a broadcast image.

Note that other arrangements and operations according to this embodiment are the same as those in the second and third embodiments described above, and a description thereof will be omitted.

As described above, according to the image processing apparatus of this embodiment, the count result of information from viewers can be displayed for a player and cameraman in real time without displaying viewer CG characters in an image composition system via interactive broadcast.

### Fifth Embodiment

The fifth embodiment of the present invention will be described below.

In this embodiment, information from each viewer is not limited to an impression to a scene or contents unlike in the second embodiment, but commands from viewers are increased so that CG characters that appear on the auditorium express various gestures, thus supporting play of a player.

Information sent from each viewer in step S1403 in FIG. 14 in the second embodiment is a command number alone. This command number indicates an impression to a scene. By preparing more commands, contents that each viewer CG character can express are enriched. For example, commands that can improve expression performance of viewer CG characters, such as a command for a gesture that points to a specific direction (right, left, up, down, back), a gesture that expresses danger, and the like are allowed to input. With these commands, when a system player loses sight of the enemy position while the game is in progress, viewers in remote places can support the player as if they were present near the player.

As described above, according to the image processing apparatus of this embodiment, by increasing the number of types of information that viewers can sent, and the number of expression patterns of viewer CG characters, a player can not only receive impressions with a sense of reality, but also his or her play can be supported by viewers in remote places, thus realizing new experience.

As described in the third embodiment, when the number of viewers becomes large, it is effective to set (limit) the auditorium area and to limit the number of viewer CG characters in that area to a specific value.

This embodiment cannot count and display overall information unlike in the third embodiment. In such case, viewers who can send information to viewer CG characters may be limited by, e.g., drawing.

### Sixth Embodiment

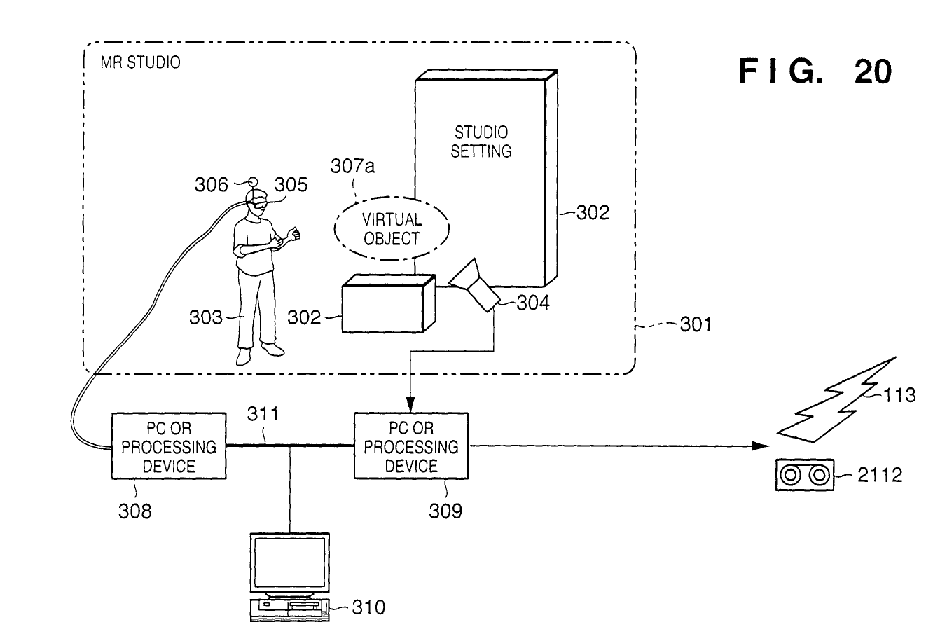

FIG. 20 is a diagram showing the system arrangement of an image processing apparatus according to this embodiment. The same reference numerals in FIG. 20 denote the same parts as in FIG. 3, and a description thereof will be omitted. The arrangement shown in FIG. 20 is different from that shown in FIG. 3 in that a video device 2112 for storing the output from the image superimpose device 109 is equipped in place of the viewer information management device 312. Also, the arrangement shown in FIG. 20 does not include any virtual object 307b that represents viewers. Furthermore, this embodiment is the same as the second embodiment for contents which are not described in the following explanation.

As shown in FIG. 20, the studio setting 302 is placed in the studio 301, and the performer 303 acts in that studio. The performer 303 wears the HMD 305 with the built-in position sensor 306, which outputs the position information of the HMD 305. Also, a camera for sensing a image of an external field is built in the HMD 305 and outputs sensed image data to the image generation device 308. The operating device 310 receives instructions for displaying and moving the virtual object 307, and transfers these instructions to the image generation device 308 and image superimpose device 309 via the network 311.

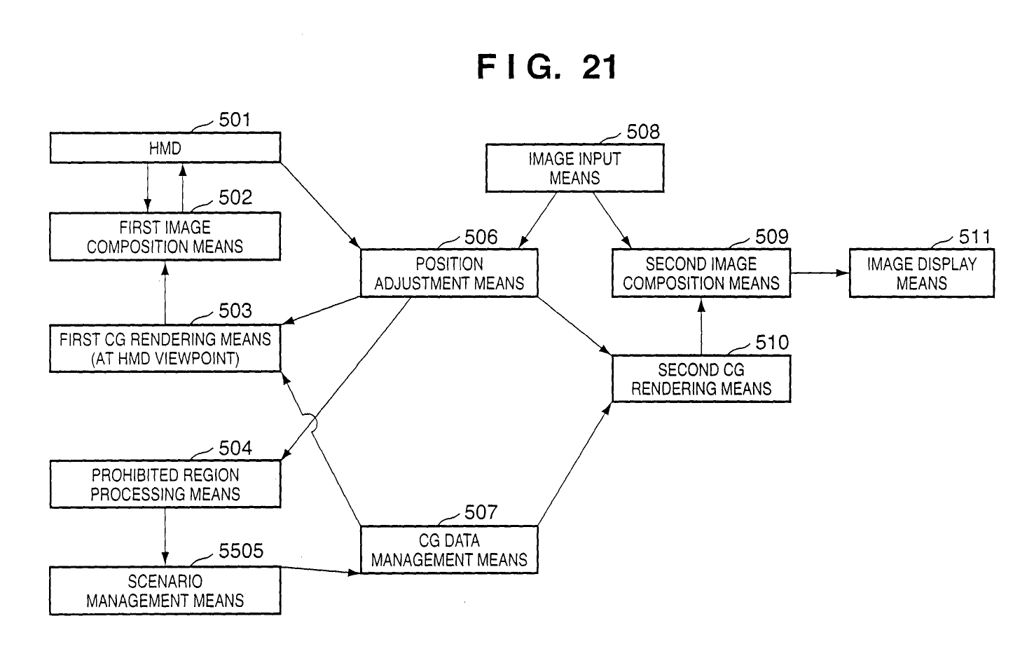

FIG. 21 is a block diagram showing details of the operation of the image processing apparatus according to this embodiment shown in FIG. 20. The same reference numeral in FIG. 21 denote the same parts as in FIG. 5, and a description thereof will be omitted. The arrangement shown in FIG. 21 is different from that shown in FIG. 5 in that the viewer information management means 512 is omitted, and a scenario management means 5505 which is different from the scenario management means 505 is equipped.

Information required for CG rendering, which is managed by the scenario management means 5505 includes the number of a CG model to be displayed, reference position/posture data, a number indicating the type of action, parameters associated with the action, and the like for each individual character to be displayed. The scenario is managed for each scene, and the aforementioned data set is selected in accordance with the status values of each character such as a power, state, and the like, the operation input from the operator, the action of the performer, and the like in each scene. For example, the number of a CG model to be displayed is determined based on the randomly selected type of character and the power value (which increases/decreases by points with the progress of a game) of that character. The operator inputs information associated with movement, rotation, and the like of the character to determine the action and parameters of the character based on such reference position, posture, and action.

The scenario management means 5505 stores information such as a script, lines, comments, and the like required to help actions, and sends required information to the CG data management means 507 in accordance with each scene. The CG data management means 507 instructs the first and second CG rendering means 503 and 510 to execute a rendering process according to such information. Each scene progresses using an arbitrary user interface (mouse, keyboard, voice input, or the like).

In this embodiment, a real-time composite image as the output from the image generation device 308 and image superimpose device 309 is used as that of the overall apparatus. Alternatively, when image data obtained by the image sensing means (or HMD) and data indicating the position/posture of the image sensing means (or HMD) are separately output, data used in so-called post-production (a process for generating a video image as a final product in a post-process by spending a long time) can be obtained at the same time.

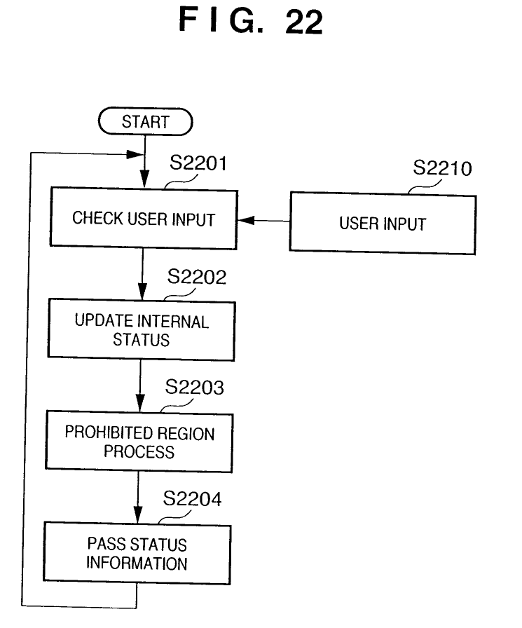

The operation of the operating device 310 in the image processing apparatus of this embodiment will be described below with reference to FIGS. 20 and 22.

FIG. 22 is a flow chart showing the flow of the processing operation of the operating device 310 in the image processing apparatus of this embodiment. In FIG. 22, step S2210 is a user input thread.

Once the process shown in FIG. 22 starts, it runs as an infinite loop until it is interrupted, and another process starts after interrupt.

The operating device 310 receives user's operation input (step S2201) in step S2210, and updates internal status data (scenario progress pointer, display mode, and the like) in accordance with the received input (step S2202). Then, the device 310 determines a prohibited region on the basis of the position information of the camera 304 and performer 303, and updates the position data so that a virtual CG object does not fall within this prohibited region (step S2203). The device 310 sends the updated internal status information to the image generation device 308 and image superimpose device 309 (step S2204). After that, the flow returns to step S2201.

As described above, user's input operation can be made using an input device such as a mouse, keyboard, or the like or via a voice input, gesture command, or the like. Also, the prohibited region process is as has been described above.

On the other hand, in case of an object which moves or deforms like the performer or the like, it is not easy to settle a spatial region occupied by that object. When the real performer or the like and virtual object approach toward each other or one of them is occluded by the other, if occlusion cannot be correctly processed, a viewer may see an object which should not be seen, or the depth ordering of these objects may be reversed upon observation, resulting in a serious visual difficulty.

In the present invention, a region where such visual difficulty is more likely to occur is set as a prohibited region, and when the virtual object enters that prohibited region, the position of the virtual object is corrected to fall outside the prohibited region, thereby removing the visual difficulty.

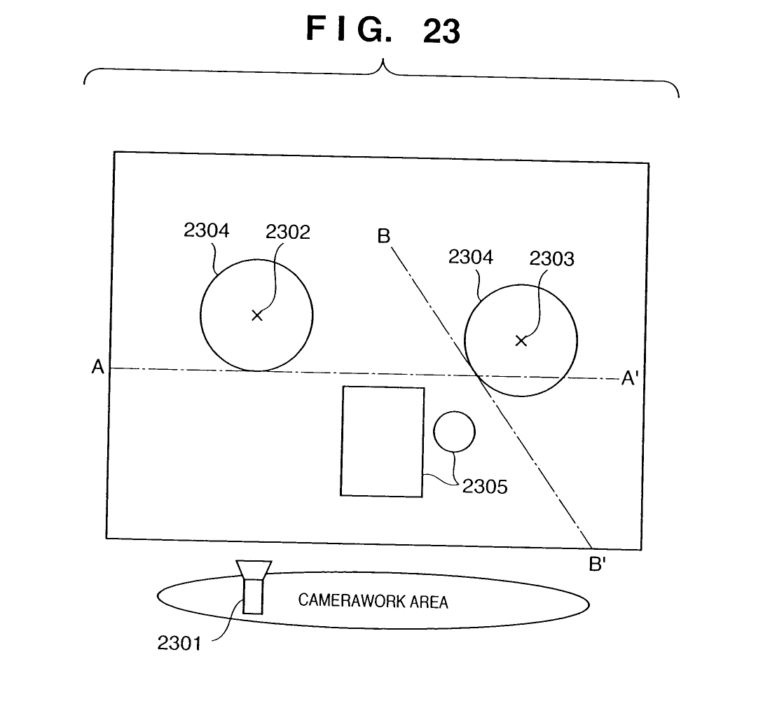

FIG. 23 is a bird's-eye view of the studio to show the simplest prohibited region. Referring to FIG. 23, reference numeral 2301 denotes a image input means (camera); 2302 and 2303, mobile real objects such as a performer and the like; 2304, surrounding regions of the performer 303 and the like; and 2305, stationary real objects (studio setting).

When a line AA′ that passes a point, which is offset from the performer 2302 toward the camera 2301 by the radius of the surrounding region 2304, on a line that connects the camera 2301 and performer 2302, and is perpendicular to that line is calculated, one of the spaces obtained by division by the line AA′, in which no camera 2301 is present, is set as a prohibited region (in practice, a region including the prohibited region is defined, but no problem is posed since that region can remove the visual difficulty). Likewise, a dividing line BB′ for another real object 2303 and its prohibited region can be calculated, and the overall prohibited region is determined as the sum set of those regions.

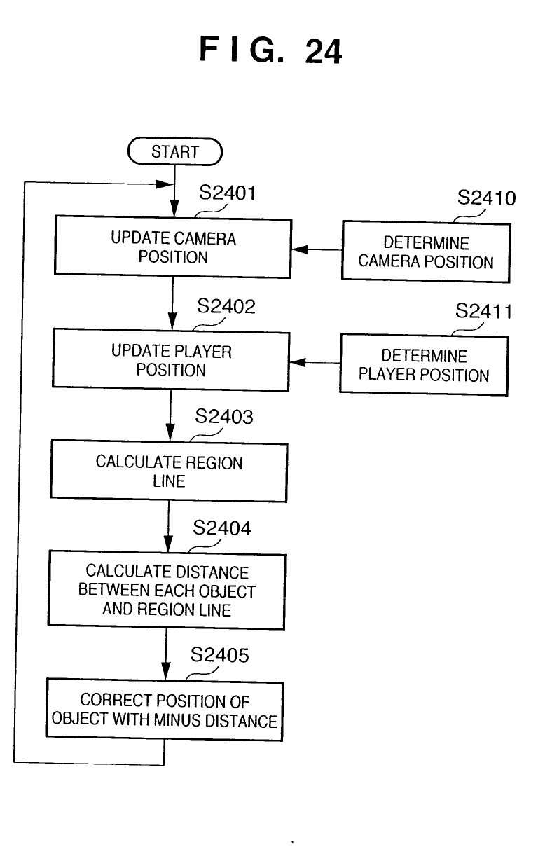

The prohibited region calculation processing operation of the prohibited region processing means 504 in the image processing device of this embodiment will be described below with reference to FIGS. 23 and 24.

FIG. 24 is a flow chart showing the flow of the prohibited region calculation processing operation of the prohibited region processing means 504 in the image processing device of this embodiment. In FIG. 24, steps S2410 and S2411 are implemented by threads, which run independently and parallelly, using a parallel processing program technique, which is widespread in the art in recent years.

Once the process shown in FIG. 24 starts, it runs as an infinite loop until it is interrupted, and another process starts after interrupt.

The position information of the camera 2301 is updated to the latest camera position (step S2401), and the position information of the performer (player) 2302 is updated to the latest player position (step S2402). A region dividing line is calculated from those pieces of information (step S2403), and the distance from the region dividing line to each virtual object is calculated (step S2404). It is checked based on the plus/minus sign of the calculated distance value if the virtual object of interest falls within the prohibited region. If the virtual object of interest falls within the prohibited region, the position of that virtual object is corrected to the closest point outside the region (this point can be calculated as the intersection between a line that connects the camera and that virtual object and the region dividing line) (step S2405). After that, the flow returns to step S2401.

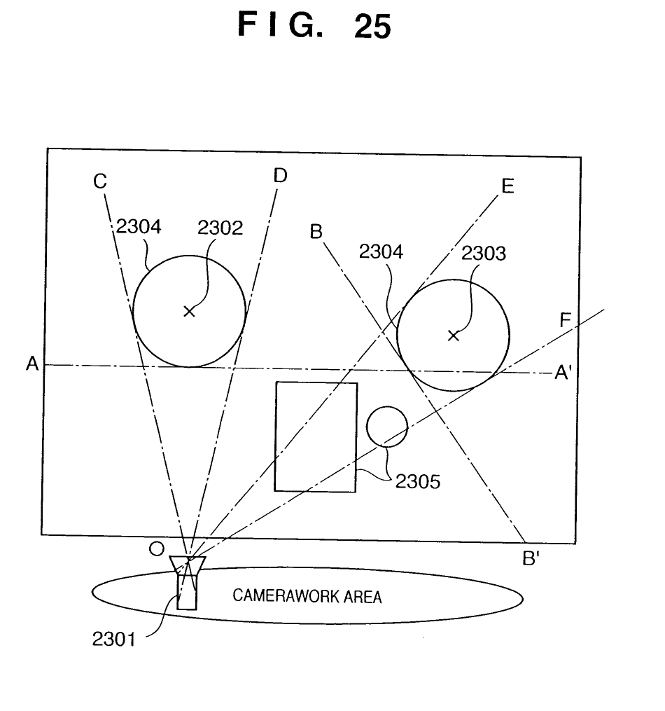

FIG. 25 shows strictly prohibited regions, and the same reference numerals in FIG. 25 denote the same parts as in FIG. 23.

FIG. 25 illustrates lines OC, OD, OE, and OF which run from the camera 2301 and are tangent to arcs indicating the surrounding regions 2304 of the performer 2302 and the like. A strictly prohibited region is, for example, a sum set of the surrounding region 2304 of the performer 2302, and a region farther than the surrounding region 2304 of a region bounded by the lines OC and OD. Such prohibited region can be easily calculated by elementary mathematics in real time as long as the processing speed is high enough.

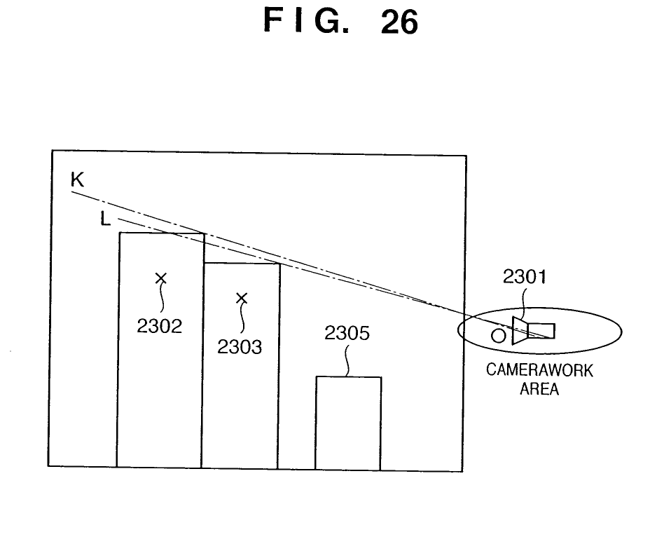

FIG. 26 is a side view of the studio to show prohibited regions, and the same reference numerals in FIG. 26 denote the same parts as in FIG. 23.

The heights of the prohibited regions can be estimated from the positions of the performer 2302 and the like, and region dividing lines are calculated as, e.g., lines OK and OL (in practice, planes which run in the lateral direction) which are tangent to them. In case of calculations in the up-and-down direction, a region where the performer 2302 and the like are present of the two regions obtained by division by the region dividing lines is defined as a prohibited region.

As described above, according to this embodiment, since the position of each virtual object is controlled by dynamically calculating the prohibited region, a high-quality composite image can be obtained in a studio system in which the user experiences a composite image of a image inputted image and CG or the like in real time.

Alternatively, in place of the real-time prohibited region process in the present invention, the sum of all possible prohibited regions may be calculated in advance on the basis of the moving ranges of the camera and performer, and each virtual object may be controlled not to enter that region. In this way, real-time calculations may be omitted.

### Seventh Embodiment

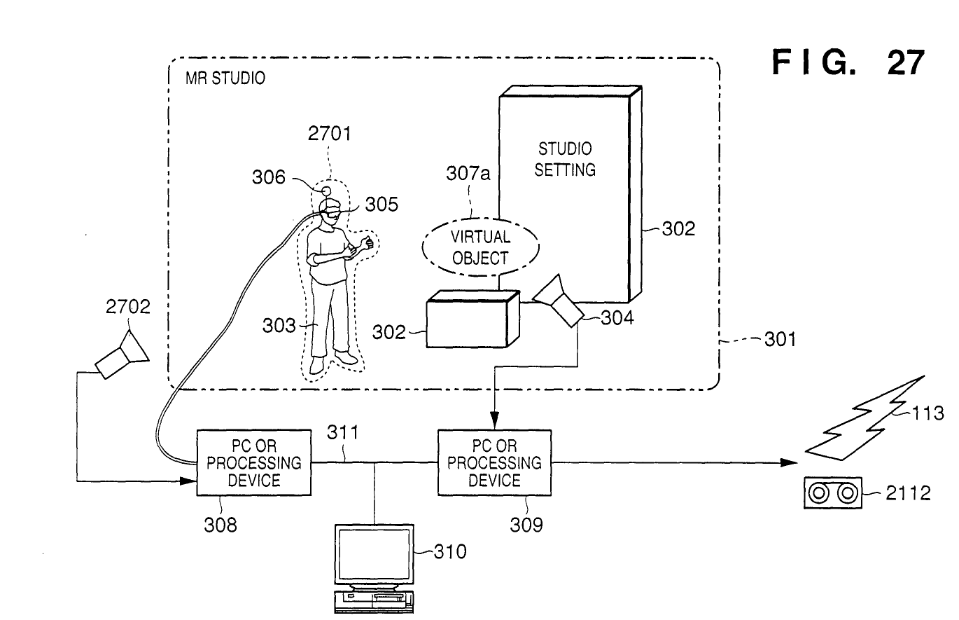

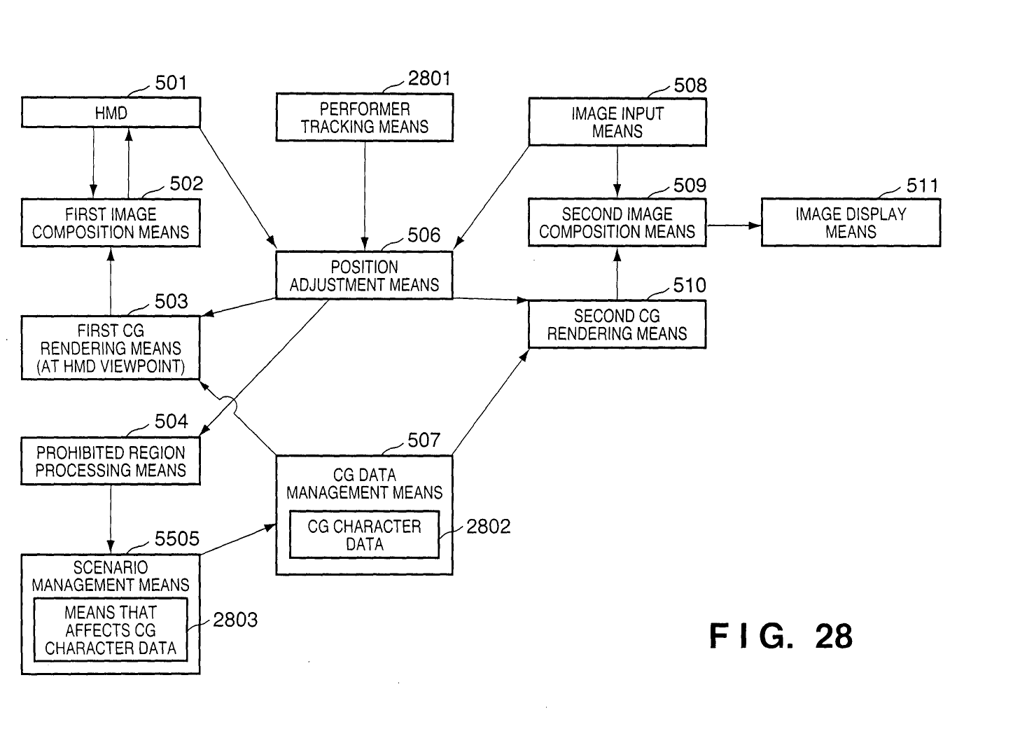

The seventh embodiment of the present invention will be described below with reference to FIGS. 27 and 28.

FIG. 27 is a diagram showing the system arrangement of an image processing apparatus according to this embodiment, and the same reference numerals in FIG. 27 denote the same parts as in FIG. 20 in the sixth embodiment mentioned above.

The arrangement shown in FIG. 27 is different from that in FIG. 20 in that a virtual costume 2701 and performer tracking device 2702 are added to the arrangement shown in FIG. 20.

The virtual costume 2701 covers the performer 303, and the performer tracking device 2702 measures the position and posture of the performer 303. The performer tracking device 2702 is generally called a motion tracking device, and a plurality of products are commercially available. For example, markers are attached to feature points associated with motions such as joints and the like of a performer, and are taken by a video camera to calculate respective marker positions while tracing the markers, or a “tower-like” device in which rotary encoders are attached to joint positions is mounted. Sensors which are the same as the position sensor 306 may be attached to feature points associated with motions. Furthermore, using a video camera which can take a image without losing depth information, the positions and postures of respective portions may be calculated based on spatial continuity and the like of a body.

FIG. 28 is a block diagram showing details of the operation of the image processing apparatus of this embodiment, and the same reference numerals in FIG. 28 denote the same parts as in FIG. 20 in the sixth embodiment mentioned above.

The arrangement shown in FIG. 28 is different from that in FIG. 21 in that a performer tracking means 2801, CG character data 2802, and means 2803 that affects CG character data are added to the arrangement in FIG. 21.

Referring to FIG. 28, the performer tracking means 2801 acquires the position/posture information of the performer from the performer tracking device 2702, and sends that information to the position adjustment means 506. The position adjustment means 506 calculates the position and posture of the performer 303 based on the received information, and sends the calculated information to the scenario management means 5505 via the prohibited region processing means 504. The scenario management means 5505 has the means 2803 that affects CG character data. The means 2803 that affects CG character data sets the position and posture of the virtual costume 3701 in correspondence with those of the performer 303. The setting result is sent to the CG data management means 507, and the CG character data 2802 managed by that CG data management means 507 undergoes manipulations such as deformation, and the like. As a result, in an image which is generated and displayed via the second CG rendering means 510, second image composition means 509, and image display means 511, since the performer 303 is present inside the virtual costume 2701, he or she is displayed as if the virtual costume 2701 were moving.

As described above, according to the present invention, the image input parameters (image input position, direction, and the like) of the image input means can be freely changed, and a composite image in which a real image (real world) and CG image (virtual world) change interactively can be displayed for both the performer and viewers, i.e., the boundary between the real and virtual worlds can be removed.

According to the present invention, the display means, measurement means that measures display parameters (display position, direction, and the like) and image composition means that composites images are arranged in the studio to allow the performer to act while observing a composite image, and to display reactions and inputs from end viewers via interactive broadcast means as virtual viewer characters or the like in the studio, thus providing novel image experience to both viewers in remote places and a player in the studio.

Furthermore, according to the present invention, the performer can act a character which is extremely larger than the performer or a character whose size, color, material, shape, and the like change along with progress of a scenario, a sense of reality can be given to a performer who wears a costume, and another performer who acts together with that performer, the physical characteristics of the character in costume can be freely set, limitations on quick actions which pose problems for a character in a real costume can be relaxed, the load on the performer due to an actual muggy costume can be reduced, and difficulty in shooting for a long period of time can be relaxed.

1. An image processing method comprising:
a image input step of taking an image using image input means, a image input parameter of which is controllable;
a image input parameter acquisition step of acquiring the image input parameter;
a CG data management step of managing CG (computer graphics) data;
a CG geometric information calculation step of calculating CG geometric information upon virtually laying out the CG data in a real world;
a CG image generation step of generating a CG image from a viewpoint of the image input means;
a image composition step of compositing a real image and the CG image; and
a image input parameter control step of changing the image input parameter using the image input parameter and the CG geometric information.

2. The method according to claim 1, further comprising the instruction input step of inputting an instruction from an operator, and wherein the image input parameter control step includes the step of changing the image input parameter additionally using the instruction from the instruction input step.

3. The method according to claim 1, further comprising the instruction input step of inputting an instruction from an operator, and wherein the CG geometric information calculation step includes the step of calculating the CG geometric information additionally using the instruction from the instruction input step.

4. The method according to claim 1, wherein a plurality of image input means equivalent to the image input means are equipped, and said method further comprises the viewpoint selection step of selecting one of the plurality of image input means.

5. The method according to claim 1, further comprising:
a display geometric information measurement step of measuring a display parameter of display means;
a second CG image generation step of generating a second CG image from a viewpoint of the display means; and
a display step of displaying the second CG image on the display means.

6. The method according to claim 1, wherein the image input parameter is a image input position of the image input means.

7. The method according to claim 1, wherein the image input parameter is a image input direction of the image input means.

8. The method according to claim 5, wherein the display parameter is a display position of the display means.

9. The method according to claim 5, wherein the display parameter is a display direction of the display means.

10. The method according to claim 1, wherein the display means is an HMD (head-mounted display).

11. The method according to claim 10, wherein the HMD is a see-through HMD of a type that allows external light to pass through a region where no image is displayed.

12. An image processing apparatus comprising:
a image input means, a image input parameter of which is controllable;
a image input parameter acquisition means that acquires the image input parameter;
a CG data management means that manages CG (computer graphics) data;
a CG geometric information calculation means that calculates CG geometric information upon virtually laying out the CG data in a real world;
a CG image generation means that generates a CG image from a viewpoint of said image input means;
a image composition means that composites a real image and the CG image; and
a image input parameter control means that changes the image input parameter using the image input parameter and the CG geometric information.

13. An image processing method comprising:
a image input step of image inputting an image using image input means;
a studio set step of forming a background;
a display step of displaying an image using display means that a staff member associated with an image process wears;
a first measurement step of measuring a image input parameter of the image input means;
a second measurement step of measuring a display parameter of the display means;
a CG data management step of managing CG (computer graphics) data;
a first CG image generation step of generating a CG image from a viewpoint of the image input means;
a image composition step of compositing an image taken by the image input means, and the CG image generated in the first CG image generation step;
a second CG image generation step of generating a CG image from a viewpoint of the display means;
a image superimpose step of superimposing the CG image on a real space that can be seen from the display means;
a image broadcast step of broadcasting an image composited in the image composition step;
a viewer information management step of managing viewer information;
a scenario management step of setting the viewer information in a portion of a scene; and
a prohibited region processing step of controlling a range in which a CG object is present.

14. The method according to claim 13, wherein the display means is an HMD (head-mounted display).

15. The method according to claim 13, wherein the image input parameter is a image input position of the image input means.

16. The method according to claim 13, wherein the image input parameter is a image input direction of the image input means.

17. The method according to claim 13, wherein the display parameter is a display position of the display means.

18. The method according to claim 13, wherein the display parameter is a display direction of the display means.

19. The method according to claim 13, wherein viewers can be displayed as virtual viewer in the image composition step and the scenario management step.

20. The method according to claim 19, further comprising the limitation step of limiting the number of CG characters displayed as viewer.

21. The apparatus according to claim 20, further comprising the control step of controlling to display a count result of all pieces of viewer information to the virtual viewer.

22. The method according to claim 20, further comprising the selection step of selecting viewers to be displayed as the virtual viewer by drawing.

23. The method according to claim 21, wherein the control step includes the step of controlling to display the count result of the viewer information on only a display screen of the display means.

24. The method according to claim 19, wherein the viewers can help a player via the virtual viewer.

25. An image processing apparatus comprising:
a image input means that image input an image;
a studio set means that forms a background;
a display means, worn by a staff member associated with an image process, for displaying an image;
a first measurement means that measures a image input parameter of said image input means;
a second measurement means that measures a display parameter of said display means;
a CG data management means that manages CG (computer graphics) data;
a first CG image generation means that generates a CG image from a viewpoint of said image input means;
a image composition means that composites an image taken by said image input means, and the CG image generated by said first CG image generation means;
a second CG image generation means that generates a CG image from a viewpoint of said display means;
a image superimpose means that superimposes the CG image on a real space that can be seen from said display means;
a image broadcast means that broadcasts an image composited by said image composition means;
a viewer information management means that manages viewer information;
a scenario management means that sets the viewer information in a portion of a scene; and
a prohibited region processing means that controls a range in which a CG object is present.

26. A studio apparatus comprising an image processing apparatus cited in claim 25.

27. A storage medium that stores a computer-readable control program for controlling an image processing apparatus for processing a real image and a CG (computer graphics) image, comprising a program code for making a computer execute:
a image input step of taking an image using image input means, a image input parameter of which is controllable;
a image input parameter acquisition step of acquiring the image input parameter;
a CG data management step of managing CG (computer graphics) data;
a CG geometric information calculation step of calculating CG geometric information upon virtually laying out the CG data in a real world;
a CG image generation step of generating a CG image from a viewpoint of the image input means;
a image composition step of compositing a real image and the CG image; and
a image input parameter control step of changing the image input parameter using the image input parameter and the CG geometric information.

28. A storage medium that stores a computer-readable control program for controlling an image processing apparatus for processing a real image and a CG (computer graphics) image, comprising a program code for making a computer execute:
a image input step of image inputting an image using image input means;
a studio set step of forming a background;
a display step of displaying an image using display means that a staff member associated with an image process wears;
a first measurement step of measuring a image input parameter of the image input means;
a second measurement step of measuring a display parameter of the display means;
a CG data management step of managing CG (computer graphics) data;
a first CG image generation step of generating a CG image from a viewpoint of the image input means;
a image composition step of compositing an image taken by the image input means, and the CG image generated in the first CG image generation step;
a second CG image generation step of generating a CG image from a viewpoint of the display means;
a image superimpose step of superimposing the CG image on a real space that can be seen from the display means;
a image broadcast step of broadcasting an image composited in the image composition step;
a viewer information management step of managing viewer information;
a scenario management step of setting the viewer information in a portion of a scene; and
a prohibited region processing step of controlling a range in which a CG object is present.

29. A computer-readable control program for controlling an image processing apparatus for processing a real image and a CG (computer graphics) image, comprising a program code for making a computer execute:
a image input step of taking an image using image input means, a image input parameter of which is controllable;
a image input parameter acquisition step of acquiring the image input parameter;
a CG data management step of managing CG (computer graphics) data;
a CG geometric information calculation step of calculating CG geometric information upon virtually laying out the CG data in a real world;
a CG image generation step of generating a CG image from a viewpoint of the image input means;
a image composition step of compositing a real image and the CG image; and
a image input parameter control step of changing the image input parameter using the image input parameter and the CG geometric information.

30. A computer-readable control program for controlling an image processing apparatus for processing a real image and a CG (computer graphics) image, comprising a program code for making a computer execute:
a image input step of image inputting an image using image input means;
a studio set step of forming a background;
a display step of displaying an image using display means that a staff member associated with an image process wears;
a first measurement step of measuring a image input parameter of the image input means;
a second measurement step of measuring a display parameter of the display means;
a CG data management step of managing CG (computer graphics) data;
a first CG image generation step of generating a CG image from a viewpoint of the image input means;
a image composition step of compositing an image taken by the image input means, and the CG image generated in the first CG image generation step;
a second CG image generation step of generating a CG image from a viewpoint of the display means;
a image superimpose step of superimposing the CG image on a real space that can be seen from the display means;
a image broadcast step of broadcasting an image composited in the image composition step;
a viewer information management step of managing viewer information;
a scenario management step of setting the viewer information in a portion of a scene; and
a prohibited region processing step of controlling a range in which a CG object is present.

31. An image processing method comprising:
a tracking step of measuring a position/posture of an object such as a performer or the like; and
an affecting CG data step of reflecting the position/posture obtained in the tracking step in CG (computer graphics) data to be superimposed on an image of the object.

32. An image processing apparatus comprising:
a tracking means that measures a position/posture of an object such as a performer or the like; and
an affecting CG data means that reflects the position/posture obtained by said tracking means in CG (computer graphics) data to be superimposed on an image of the object.

33. An image processing method for measuring a position/posture of an object such as a performer or the like, and reflecting the measured position/posture in CG (computer graphics) data to be superimposed on an image of the object to display the CG data on display means, comprising:
a image input step of image inputting the object using image input means;
a CG image generation step of generating a CG image from a viewpoint of the image input means on the basis of a image input parameter of the image input means and a display parameter of the display means;
a image composition step of compositing a real image of the object taken by the image input means with the CG image generated in the CG image generation step, and displaying a composite image on the display means; and
a prohibited region processing step of limiting in the image composition step a range in which the CG image is present.

34. The method according to claim 33, wherein the CG image generation step comprises the scenario management step of managing scenario information used to generate the CG.

35. The method according to claim 33, wherein the image input parameter is a image input position of the image input means.

36. The method according to claim 33, wherein the image input parameter is a image input direction of the image input means.

37. The method according to claim 33, wherein the display parameter is a display position of the display means.

38. The method according to claim 33, wherein the display parameter is a display direction of the display means.

39. The method according to claim 33, wherein the display means is an HMD (head-mounted display).

40. An image processing apparatus for measuring a position/posture of an object such as a performer or the like, and reflecting the measured position/posture in CG (computer graphics) data to be superimposed on an image of the object to display the CG data on display means, comprising:
image input means that image input the object;
CG image generation means that generates a CG image from a viewpoint of said image input means on the basis of a image input parameter of said image input means and a display parameter of the display means;
image composition means that composites a real image of the object taken by said image input means with the CG image generated by said CG image generation means, and displaying a composite image on the display means; and
prohibited region processing means that limits in an image composition process of said image composition means a range in which the CG image is present.

41. A storage medium that stores a computer-readable control program for controlling an image processing apparatus for processing a real image and a CG (computer graphics) image, comprising a program code for making a computer execute:
a tracking step of measuring a position/posture of an object such as a performer or the like; and
an affecting CG data step of reflecting the position/posture obtained in the tracking step in CG (computer graphics) data to be superimposed on an image of the object.

42. A storage medium that stores a computer-readable control program for controlling an image process for measuring a position/posture of an object such as a performer or the like, and reflecting the measured position/posture in CG (computer graphics) data to be superimposed on an image of the object to display the CG data on display means in an image processing apparatus for processing a real image and a CG (computer graphics) image, comprising a program code for making a computer execute:
a image input step of image inputting the object using image input means;
a image generation step of generating a CG image from a viewpoint of the image input means on the basis of a image input parameter of the image input means and a display parameter of the display means;
a image composition step of compositing a real image of the object taken by the image input means with the CG image generated in the CG image generation step, and displaying a composite image on the display means; and
a prohibited region processing step of limiting in the image composition step a range in which the CG image is present.

43. The medium according to claim 42, further comprising the studio set step of forming a background, the display step of displaying an image using display means that a performer or a person associated with image input wears, and the scenario management step of managing scenario information used to generate the CG image.

44. A computer-readable control program for controlling an image processing apparatus for processing a real image and a CG (computer graphics) image, comprising a program code for making a computer execute:
a tracking step of measuring a position/posture of an object such as a performer or the like; and
an affecting CG data step of reflecting the position/posture obtained in the tracking step in CG (computer graphics) data to be superimposed on an image of the object.

45. A computer-readable control program for controlling an image process for measuring a position/posture of an object such as a performer or the like, and reflecting the measured position/posture in CG (computer graphics) data to be superimposed on an image of the object to display the CG data on display means in an image processing apparatus for processing a real image and a CG (computer graphics) image, comprising a program code for making a computer execute:
a image input step of image inputting the object using image input means;
a CG image generation step of generating a CG image from a viewpoint of the image input means on the basis of a image input parameter of the image input means and a display parameter of the display means;
a image composition step of compositing a real image of the object taken by the image input means with the CG image generated in the CG image generation step, and displaying a composite image on the display means; and
a prohibited region processing step of limiting in the image composition step a range in which the CG image is present.

46. The program according to claim 45, further comprising the studio set step of forming a background, the display step of displaying an image using display means that a performer or a person associated with image input wears, and the scenario management step of managing scenario information used to generate the CG image.
